(19) United States
(12) Patent Application Publication
(10) Pub. No.: US 2024/0381484 A1
(43) Pub. Date: Nov. 14, 2024

(54) Connected Mode Discontinuous Reception in a Wireless Communication Network

(71) Applicant: Telefonaktiebolaget LM Ericsson (publ), Stockholm (SE)

(72) Inventors: Sina Maleki, Malmö (SE); Ali Nader, Malmö (SE); Ilmiawan Shubhi, Malmö (SE); Du Ho Kang, Sollentuna (SE)

(21) Appl. No.: 18/690,319

(22) PCT Filed: Sep. 13, 2022
(86) PCT No.: PCT/EP2022/075441

§ 371 Date: Mar. 8, 2024

Related U.S. Application Data
(60) Provisional application No. 63/243,714, filed on Sep. 13, 2021.

(51) Int. Cl. H04W 76/28; H04L 43/08; H04W 52/36; H04W 76/38

(52) U.S. Cl. CPC H04W 76/28; H04L 43/08; H04W 52/367; H04W 76/38

(57) ABSTRACT

A wireless communication device (12) transmits assistance information (24) to a wireless communication network (10). The assistance information (24) may indicate a preference (24A) of the wireless communication device (12) for each of one or more retransmission parameters (22) that control retransmission in connected mode discontinuous reception, C-DRX, operation. Alternatively or additionally, the assistance information (24) may indicate a value (24B) measured by the wireless communication device (12) for each of one or more retransmission metrics that describe retransmission in C-DRX operation. Alternatively or additionally, the assistance information (24) may indicate a value (24C) measured by the wireless communication device (12) for each of one or more traffic metrics that describe uplink or downlink data traffic in C-DRX operation.

### TECHNICAL FIELD

The present application relates generally to a wireless communication network, and more particularly relates to connected mode discontinuous reception in such a network.

### BACKGROUND

A wireless communication device in a wireless communication network must monitor a downlink control channel in order to receive control messages intended for the device, e.g., scheduling messages that schedule downlink or uplink transmissions for the device. A wireless communication device that has a connection, such as a Radio Resource Control (RRC) connection, with the wireless communication network is able to only discontinuously monitor the downlink control channel using connected mode discontinuous reception (C-DRX) operation. Monitoring the downlink control channel only discontinuously conserves device power.

Despite the improvement in device power consumption attributable to C-DRX operation, challenges nonetheless exist in optimizing device power consumption. For example, after performing an uplink transmission to the wireless communication network, the wireless communication device must monitor the downlink control channel for any control message requesting that the wireless communication device re-transmit the uplink transmission. Although such re-transmission facilitates reliable uplink transmission, the required downlink control channel monitoring consumes meaningful power at the wireless communication device and correspondingly limits the power conservation available from C-DRX operation.

### SUMMARY

According to some embodiments herein, a wireless communication device transmits assistance information to a wireless communication network. In some embodiments, the assistance information indicates a preference of the wireless communication device for each of one or more retransmission parameters that control retransmission in C-DRX operation, e.g., where the parameter(s) may for instance configure timer(s) that govern or impact C-DRX active time. In other embodiments, the assistance information alternatively or additionally indicates a value measured by the wireless communication device for each of one or more retransmission metrics that describe retransmission in C-DRX operation. The assistance information in these and other embodiments may assist the wireless communication network with controlling or configuring retransmission in C-DRX operation. For example, in some embodiments, the wireless communication network uses or otherwise takes into account the assistance information to configure one or more retransmission parameters for C-DRX operation. The network may for instance exploit the assistance information to configure one or more timers that govern or impact for how long the wireless communication device will monitor a downlink control channel for a message requesting an uplink retransmission. Exploiting the assistance information in this way may advantageously reduce the amount of time that the wireless communication device monitors the downlink control channel, so as to thereby reduce the device's power consumption and prolong the device's battery life.

More particularly, embodiments herein include a method performed by a wireless communication device. The method comprises transmitting, to a wireless communication network, assistance information. The assistance information may indicate (i) a preference of the wireless communication device for each of one or more retransmission parameters that control retransmission in connected mode discontinuous reception, C-DRX, operation; (ii) a value measured by the wireless communication device for each of one or more retransmission metrics that describe retransmission in C-DRX operation; and/or (iii) a value measured by the wireless communication device for each of one or more traffic metrics that describe uplink or downlink data traffic in C-DRX operation.

In some embodiments, the assistance information indicates a preference of the wireless communication device for each of one or more retransmission parameters that control retransmission in C-DRX operation.

In some embodiments, at least one of the one or more retransmission parameters controls a timing of retransmission in C-DRX operation. Additionally or alternatively, at least one of the one or more retransmission parameters controls a timing of control signaling for controlling retransmission in C-DRX operation.

In some embodiments, the one or more retransmission parameters include one or more of a downlink retransmission timer that controls a maximum duration until a downlink retransmission is received, an uplink retransmission timer that controls a maximum duration until a grant for an uplink retransmission is received, a downlink hybrid automatic repeat request, HARQ, round-trip time timer that controls a minimum duration before a downlink assignment for HARQ retransmission is expected by a medium access control, MAC, entity, and an uplink HARQ round-trip time timer that controls a minimum duration before an uplink HARQ retransmission grant is expected by a MAC entity.

In some embodiments, at least one of the one or more retransmission parameters controls a maximum number of uplink and/or downlink retransmissions in C-DRX operation.

In some embodiments, at least one of the one or more retransmission parameters controls a maximum window of time within which any retransmission of an original transmission is transmittable since the original transmission was transmitted or scheduled.

In some embodiments, the assistance information provides one or more preferred values for the one or more retransmission parameters, respectively.

In some embodiments, the assistance information indicates a value measured by the wireless communication device for each of one or more retransmission metrics that describe retransmission in C-DRX operation.

In some embodiments, at least one of the one or more retransmission metrics describes an amount of time that the wireless communication device has monitored for a retransmission that never came. In one or more of these embodiments, the at least one of the one or more retransmission metrics indicates the amount of time absolutely, indicates the amount of time as a portion of a wake-up time, or indicates whether the amount of time is increasing or decreasing over time. In one or more of these embodiments, the amount of time is the average amount of time that the wireless communication device has monitored for a retransmission that never came. In one or more of these embodiments, at least one of the one or more retransmission metrics is a statistical metric.

In some embodiments, the assistance information indicates a value measured by the wireless communication device for each of one or more traffic metrics that describe uplink or downlink data traffic in C-DRX operation.

In some embodiments, at least one of the one or more traffic metrics indicates a delay budget for uplink or downlink data traffic in C-DRX operation, a traffic arrival periodicity for uplink or downlink data traffic in C-DRX operation, a jitter for uplink or downlink data traffic in C-DRX operation, a packet size for uplink or downlink data traffic in C-DRX operation, a quality of service flow identifier for uplink or downlink data traffic in C-DRX operation, or a buffer size for uplink or downlink data traffic in C-DRX operation. In one or more of these embodiments, the at least one of the one or more traffic metrics is a statistical metric.

In some embodiments, the assistance information comprises assistance information specific for each of one or more quality of service flows or data radio bearers.

In some embodiments, the assistance information is user equipment, UE, assistance information, UAI.

In some embodiments, the method further comprises receiving, from the wireless communication network, configuration signaling that configures the wireless communication device to provide said assistance information.

In some embodiments, the method further comprises receiving, from the wireless communication network, configuration signaling that configures, for at least one retransmission parameter of the one or more retransmission parameters, a set of values from which the wireless communication device is allowed to provide a preferred value for the at least one retransmission parameter. In one or more of these embodiments, the set of values is a proper subset of a set of allowed values. In one or more of these embodiments, the proper subset includes one or more values that are smaller than a value currently configured for the at least one retransmission parameter.

In some embodiments, the method further comprises, upon transmitting the assistance information, starting a prohibit timer that, while the prohibit timer is running, prohibits the transmission of assistance information which provides a preference of the wireless communication device on any of the one or more retransmission parameters or assistance information which provides a preference of the wireless communication device on a subset of the one or more retransmission parameters.

Other embodiments herein include a method performed by a network node configured for use in a wireless communication network. The method comprises receiving, from a wireless communication device, assistance information. The assistance information may indicate (i) a preference of the wireless communication device for each of one or more retransmission parameters that control retransmission in connected mode discontinuous reception, C-DRX, operation; (ii) a value measured by the wireless communication device for each of one or more retransmission metrics that describe retransmission in C-DRX operation; and/or (iii) a value measured by the wireless communication device for each of one or more traffic metrics that describe uplink or downlink data traffic in C-DRX operation.

In some embodiments, the assistance information indicates a preference of the wireless communication device for each of one or more retransmission parameters that control retransmission in C-DRX operation.

In some embodiments, at least one of the one or more retransmission parameters controls a timing of retransmission in C-DRX operation. Additionally or alternatively, at least one of the one or more retransmission parameters controls a timing of control signaling for controlling retransmission in C-DRX operation.

In some embodiments, the one or more retransmission parameters include one or more of a downlink retransmission timer that controls a maximum duration until a downlink retransmission is received, an uplink retransmission timer that controls a maximum duration until a grant for an uplink retransmission is received, a downlink hybrid automatic repeat request, HARQ, round-trip time timer that controls a minimum duration before a downlink assignment for HARQ retransmission is expected by a medium access control, MAC, entity, and an uplink HARQ round-trip time timer that controls a minimum duration before an uplink HARQ retransmission grant is expected by a MAC entity.

In some embodiments, wherein at least one of the one or more retransmission parameters controls a maximum number of uplink and/or downlink retransmissions in C-DRX operation.

In some embodiments, at least one of the one or more retransmission parameters controls a maximum window of time within which any retransmission of an original transmission is transmittable since the original transmission was transmitted or scheduled.

In some embodiments, the assistance information provides one or more preferred values for the one or more retransmission parameters, respectively.

In some embodiments, the assistance information indicates a value measured by the wireless communication device for each of one or more retransmission metrics that describe retransmission in C-DRX operation.

In some embodiments, at least one of the one or more retransmission metrics describes an amount of time that the wireless communication device has monitored for a retransmission that never came. In one or more of these embodiments, the at least one of the one or more retransmission metrics indicates the amount of time absolutely, indicates the amount of time as a portion of a wake-up time, or indicates whether the amount of time is increasing or decreasing over time. In one or more of these embodiments, the amount of time is the average amount of time that the wireless communication device has monitored for a retransmission that never came. In one or more of these embodiments, at least one of the one or more retransmission metrics is a statistical metric.

In some embodiments, the assistance information indicates a value measured by the wireless communication device for each of one or more traffic metrics that describe uplink or downlink data traffic in C-DRX operation.

In some embodiments, at least one of the one or more traffic metrics indicates a delay budget for uplink or downlink data traffic in C-DRX operation, a traffic arrival periodicity for uplink or downlink data traffic in C-DRX operation, a jitter for uplink or downlink data traffic in C-DRX operation, a packet size for uplink or downlink data traffic in C-DRX operation, a quality of service flow identifier for uplink or downlink data traffic in C-DRX operation, or a buffer size for uplink or downlink data traffic in C-DRX operation. In one or more of these embodiments, the at least one of the one or more traffic metrics is a statistical metric.

In some embodiments, the assistance information comprises assistance information specific for each of one or more quality of service flows or data radio bearers.

In some embodiments, the assistance information is user equipment, UE, assistance information, UAI.

In some embodiments, the method further comprises transmitting, to the wireless communication device, configuration signaling that configures the wireless communication device to provide said assistance information.

In some embodiments, the method further comprises transmitting, to the wireless communication device, configuration signaling that configures, for at least one retransmission parameter of the one or more retransmission parameters, a set of values from which the wireless communication device is allowed to provide a preferred value for the at least one retransmission parameter. In one or more of these embodiments, the set of values is a proper subset of a set of allowed values. In one or more of these embodiments, the proper subset includes one or more values that are smaller than a value currently configured for the at least one retransmission parameter.

In some embodiments, the method further comprises transmitting, to the wireless communication device, configuration signaling that configures a value of a prohibit timer of the wireless communication device. While the prohibit timer is running at the wireless communication device, the prohibits the transmission of assistance information which provides a preference of the wireless communication device on any of the one or more retransmission parameters, or assistance information which provides a preference of the wireless communication device on a subset of the one or more retransmission parameters. In some embodiments, the method further comprises based on the received assistance information, configuring or controlling retransmission in C-DRX operation. In one or more of these embodiments, configuring or controlling comprises configuring one or more retransmission parameters that control retransmission in C-DRX operation. In one or more of these embodiments, configuring one or more retransmission parameters comprises configuring one or more of a downlink retransmission timer that controls a maximum duration until a downlink retransmission is received, an uplink retransmission timer that controls a maximum duration until a grant for an uplink retransmission is received, a downlink hybrid automatic repeat request, HARQ, round-trip time timer that controls a minimum duration before a downlink assignment for HARQ retransmission is expected by a medium access control, MAC, entity, and an uplink HARQ round-trip time timer that controls a minimum duration before an uplink HARQ retransmission grant is expected by a MAC entity. In one or more of these embodiments, the assistance information comprises assistance information specific for each of one or more quality of service, QoS, flows or data radio bearers, DRBs. In this case, configuring one or more retransmission parameters that control retransmission in C-DRX operation comprises, for each of the one or more QoS flows or DRBs, configuring a respective set of one or more retransmission parameters that is specific to that QoS flow or DRB, and the method further comprises transmitting signaling that indicates which set of one or more retransmission parameters is active. In one or more of these embodiments, the assistance information comprises assistance information specific for each of multiple quality of service, QoS, flows or data radio bearers, DRBs. In this case, the method further comprises configuring the wireless communication device with multiple sets of one or more transmission parameters that control retransmission in C-DRX operation and that are specific to respective ones of the multiple QoS flows or DRBs. In one or more of these embodiments, the method further comprises dynamically or semi-statically activating a set of one or more transmission parameters, from the multiple sets of one or more transmission parameters, for a transmission associated with the QoS flow or DRB specific to that set. In one or more of these embodiments, activating comprises transmitting, in a grant or assignment scheduling the transmission, explicit signaling that activates the set.

Embodiments herein also include corresponding apparatus, computer programs, and carriers of those computer programs.

For example, embodiments herein include a wireless communication device, e.g., comprising communication circuitry and processing circuitry. The wireless communication device is configured to transmit, to a wireless communication network, assistance information.

The assistance information may indicate (i) a preference of the wireless communication device for each of one or more retransmission parameters that control retransmission in connected mode discontinuous reception, C-DRX, operation; (ii) a value measured by the wireless communication device for each of one or more retransmission metrics that describe retransmission in C-DRX operation; and/or (iii) a value measured by the wireless communication device for each of one or more traffic metrics that describe uplink or downlink data traffic in C-DRX operation.

Embodiments further include a network node configured for use in a wireless communication network. The network node may for example include communication circuitry and processing circuitry. The network node is configured to receive, from a wireless communication device, assistance information. The assistance information may indicate (i) a preference of the wireless communication device for each of one or more retransmission parameters that control retransmission in connected mode discontinuous reception, C-DRX, operation; (ii) a value measured by the wireless communication device for each of one or more retransmission metrics that describe retransmission in C-DRX operation; and/or (iii) a value measured by the wireless communication device for each of one or more traffic metrics that describe uplink or downlink data traffic in C-DRX operation.

### BRIEF DESCRIPTION OF THE DRAWINGS

FIG. 1 is a block diagram of a wireless communication network according to some embodiments.

FIG. 2 is a block diagram of an uplink-related scenario prevented by some embodiments herein.

FIGS. 3A-3B are block diagrams of monitoring periods for uplink transmission and downlink transmission that are configured according to some embodiments herein.

FIG. 4 is a logic flow diagram of a method performed by a wireless communication device according to some embodiments.

FIG. 5 is a logic flow diagram of a method performed by a network node according to some embodiments.

FIG. 6 is a block diagram of a wireless communication device according to some embodiments.

FIG. 7 is a block diagram of a network node according to some embodiments.

FIG. 8 is a block diagram of a communication system in accordance with some embodiments

FIG. 9 is a block diagram of a user equipment according to some embodiments.

FIG. 10 is a block diagram of a network node according to some embodiments.

FIG. 11 is a block diagram of a host according to some embodiments.

FIG. 12 is a block diagram of a virtualization environment according to some embodiments.

FIG. 13 is a block diagram of a host communicating via a network node with a UE over a partially wireless connection in accordance with some embodiments.

### DETAILED DESCRIPTION

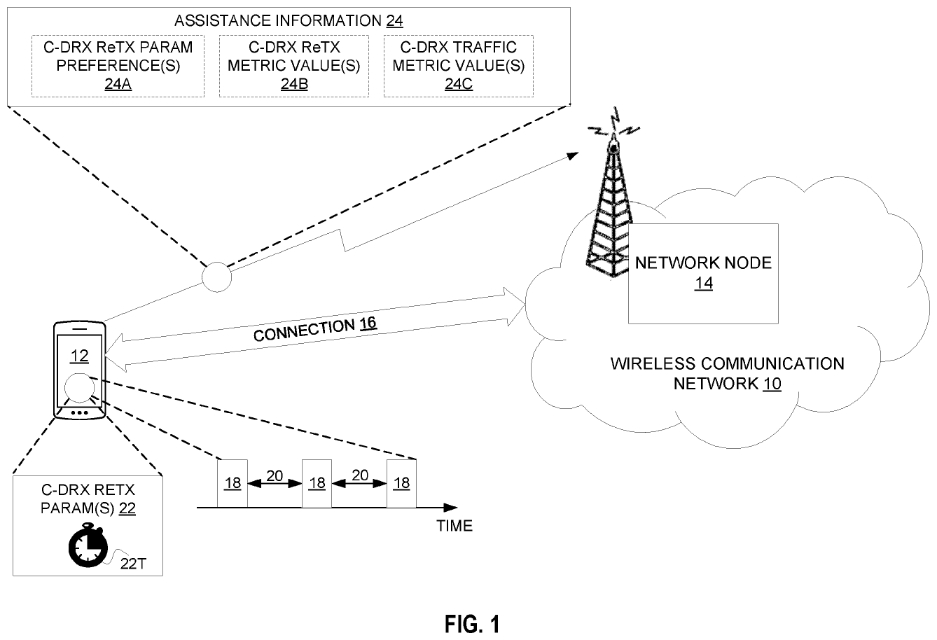

FIG. 1 shows a wireless communication network 10 that provides wireless communication service to a wireless communication device 12 according to some embodiments. The wireless communication device 12 is configurable to establish a connection 16 with the wireless communication network 14. The connection 16 may for instance be at a Radio Resource Control (RRC) layer, in which case the connection 16 is an RRC connection. When the wireless communication device 12 is connected to the wireless communication network 10 via connection 16, the wireless communication device 12 may be said to operate in a so-called connected mode, e.g., an RRC connected mode in which RRC parameters necessary for communication are known to both the wireless communication device 12 and the wireless communication network 10.

While in the connected mode, the wireless communication device 12 may monitor a downlink control channel (not shown) in order to receive control messages intended for the device 12, e.g., scheduling messages that schedule downlink or uplink transmissions for the device 12. The downlink control channel may for instance be a Physical Downlink Control Channel (PDCHH). Regardless, rather than monitoring the downlink control channel continuously, the wireless communication device 12 may exploit so-called connected mode discontinuous reception (C-DRX) operation, e.g., at a Medium Access Control (MAC) layer, in order to only discontinuously monitor the downlink control channel. Monitoring the downlink control channel only discontinuously conserves device power. As shown, for instance, in C-DRX operation, the wireless communication device 12 only monitors the downlink control channel during active times 18 that occur discontinuously in time. When the wireless communication device 12 is not monitoring the downlink control channel, during non-active times 20, the wireless communication device 12 may conserve power, e.g., by operating in a sleep state in which the wireless communication device 12 turns off one or more components or circuits.

In this context, one or more parameters 22 at the wireless communication device 12 control retransmission in C-DRX operation, e.g., where the parameter(s) 22 may be appropriately referred to as retransmission parameter(s) 22. Retransmission in this regard refers to retransmission of an original transmission that was not successfully received. Retransmission may for example encompass the retransmission by the wireless communication device 12 of an original uplink transmission that was not successfully received by the wireless communication network 10 and/or the retransmission by the wireless communication network 10 of an original downlink transmission that was not successfully received by the wireless communication device 12. Note, too, that retransmission of an original transmission may encompass the transmission of any one of multiple redundancy versions of the original transmission, e.g., where the retransmission is part of an adaptive Hybrid Automatic Repeat Request (HARQ) process where each retransmission uses different redundancy versions.

In some embodiments, at least one of the retransmission parameter(s) 22 controls a timing of retransmission in C-DRX operation and/or a timing of control signaling for retransmission in C-DRX operation. In these and other embodiments, as shown in FIG. 1, the retransmission parameter(s) 22 may include one or more timers 22T, e.g., which govern or impact C-DRX active time. The timer(s) 22T may for example include one or more of: (i) a downlink retransmission timer (e.g., drx-RetransmissionTimerDL) that controls a maximum duration until a downlink retransmission is received; (ii) an uplink retransmission timer (e.g., drx-RetransmissionTimerUL) that controls a maximum duration until a grant for an uplink retransmission is received; (iii) a downlink hybrid automatic repeat request, HARQ, round-trip time timer (e.g., drx-HARQ-RTT-TimerdL) that controls a minimum duration before a downlink assignment for HARQ retransmission is expected by a medium access control, MAC, entity; and/or (iv) an uplink HARQ round-trip time timer (e.g., drx-HARQ-RTT-TimerUL) that controls a minimum duration before an uplink HARQ retransmission grant is expected by a MAC entity.

In other embodiments, at least one of the retransmission parameter(s) 22 alternatively or additionally controls a maximum number of uplink and/or downlink retransmissions in C-DRX operation. The maximum number of downlink retransmissions may for instance be controlled by a parameter maxNbrPreferredRxTx_DL.

In still other embodiments, at least one of the retransmission parameter(s) 22 alternatively or additionally controls a maximum window of time within which any retransmission of an original transmission is transmittable since the original transmission was transmitted or scheduled. The maximum window of time may for example be specified in terms of slots, milliseconds, or the like.

No matter the particular nature of the C-DRX retransmission parameter(s) 22, the wireless communication device 12 as shown in FIG. 1 transmits assistance information 24 to the wireless communication network 10. In embodiments where the wireless communication device 12 takes the form of a user equipment (UE), the assistance information 24 may be referred to as UE assistance information (UAI). Regardless, the assistance information 24 in these and other embodiments may assist the wireless communication network 10 with controlling or configuring retransmission in C-DRX operation. For example, in some embodiments, the wireless communication network 10 uses or otherwise takes into account the assistance information 24 to configure the one or more retransmission parameters 22 for C-DRX operation. The network may for instance exploit the assistance information 24 to configure the one or more timers 22T that govern or impact for how long the wireless communication device 12 will monitor a downlink control channel for a message requesting an uplink retransmission. Exploiting the assistance information 24 in this way may advantageously reduce the amount of time that the wireless communication device 12 monitors the downlink control channel, so as to thereby reduce the device's power consumption and prolong the device's battery life.

More particularly, in some embodiments, the assistance information 24 indicates a preference 24A of the wireless communication device 12 for each of the one or more retransmission parameters 22 that control retransmission in C-DRX operation. In this case, the assistance information 24 may for example provide one or more preferred values for the one or more retransmission parameters 22, respectively. For instance, the assistance information 24 may provide (i) a preferred value for the downlink retransmission timer that controls a maximum duration until a downlink retransmission is received; (ii) a preferred value for the uplink retransmission timer that controls a maximum duration until a grant for an uplink retransmission is received; (iii) a preferred value for the downlink HARQ RTT timer that controls a minimum duration before a downlink assignment for HARQ retransmission is expected by a MAC entity; and/or (iv) a preferred value for the uplink HARQ RTT timer that controls a minimum duration before an uplink HARQ retransmission grant is expected by a MAC entity. Alternatively or additionally, the assistance information 24 may provide (i) a preferred value for a retransmission parameter 22 that controls a maximum window of time within which any retransmission of an original transmission is transmittable since the original transmission was transmitted or scheduled; and/or (ii) a preferred value for a retransmission parameter that controls a maximum number of uplink and/or downlink retransmissions in C-DRX operation. The wireless communication device 12 may form such preference(s) 24A based for example on the type(s) of traffic relevant for the device 12, the channel conditions at the device 12, and/or delay constraints or quality of service requirements at the device 12. In any event, where the assistance information 24 indicates a preference 24A of the wireless communication device 12 for each of the one or more retransmission parameters 22, the wireless communication network 10 may use or otherwise take into account the indicated preference(s) 24A when deciding on how to configure the one or more retransmission parameters 22 for C-DRX operation.

In other embodiments, the assistance information 24 alternatively or additionally indicates a value 24B measured by the wireless communication device 12 for each of one or more retransmission metrics that describe retransmission in C-DRX operation. At least one of the retransmission metric(s) may be a statistical metric. For example, in these and other embodiments, at least one of the one or more retransmission metrics may describe an amount of time (e.g., on average) that the wireless communication device 12 has monitored for a retransmission that never came and/or an amount of time (e.g., on average) that the wireless communication device 12 has monitored for an assignment or grant (for a retransmission) that never came. Such retransmission metric may be referred to as describing redundant waiting time, since it describes the time that the wireless communication device 12 has needlessly or redundantly waited for a retransmission or for an assignment/grant for retransmission. In these and other embodiments where the assistance information 24 indicates value(s) 24B for retransmission metric(s), the wireless communication network 10 may similarly use or otherwise take into account the indicated value(s) 24B when deciding on how to configure the one or more retransmission parameters 22 for C-DRX operation. Indeed, the value(s) 24B for the retransmission metric(s) may provide some insight into what the wireless communication device's preference would or should be for those retransmission parameter(s) 22 for C-DRX operation. For instance, if the reported value(s) for the retransmission metric(s) indicate the wireless communication device 12 has excessive redundant waiting time, the wireless communication network 10 may adapt the timer(s) 22T in such a way that reduces the device's redundant waiting time.

Alternatively or additionally to the above embodiments, in one or more embodiments the assistance information 24 in FIG. 1 may indicate a value 24C measured by the wireless communication device 12 for each of one or more traffic metrics that describe uplink or downlink data traffic in C-DRX operation. For example, in some embodiments, at least one of the one or more traffic metrics indicates: a delay budget for uplink or downlink data traffic in C-DRX operation; a traffic arrival periodicity for uplink or downlink data traffic in C-DRX operation; a jitter for uplink or downlink data traffic in C-DRX operation; a packet size for uplink or downlink data traffic in C-DRX operation; a quality of service flow identifier for uplink or downlink data traffic in C-DRX operation; or a buffer size for uplink or downlink data traffic in C-DRX operation. The wireless communication network 10 may similarly use or otherwise take into account the indicated value(s) 24C when deciding on how to configure the one or more retransmission parameters 22 for C-DRX operation.

Although described generally for the wireless communication device 12 as a whole, some embodiments herein may apply on a quality of service (QoS) QoS flow by QoS flow basis and/or on a data radio bearer by data radio bearer basis. For example, in some embodiments, the assistance information 24 comprises assistance information specific for each of one or more quality of service (QoS) flows or data radio bearers (DRBs), e.g., such the assistance information 24 includes respective sets of assistance information for different QoS flows or DRBs. In this case, then, the wireless communication network 10 may configure a respective set of one or more retransmission parameters that is specific to each QoS flow or DRB. In one or more such embodiments, the wireless communication network 10 may dynamically or semi-statically activate one retransmission parameter set at a time, e.g., via explicit signaling in a grant or assignment scheduling a transmission.

Consider now some embodiments presented in an example context where the wireless communication device 12 is exemplified as a user equipment (UE), the connection 16 is exemplified as an RRC connection, and the assistance information 24 is exemplified as UAI. Some embodiments are described using a 5G or New Radio (NR) wireless communication network 10.

### DRX Mode

Some embodiments herein are applicable for NR DRX operation as described in Clause 5.7 in TS 38.321 v16.5.0. According to Clause 5.7 in TS 38.321 v16.5.0, the MAC entity may be configured by RRC with a discontinuous reception (DRX) functionality that controls the UE's physical downlink control channel (PDCCH) monitoring activity.

In this case, RRC controls DRX operation by configuring the following parameters:
drx-onDurationTimer: the duration at the beginning of a DRX Cycle;
drx-SlotOffset: the delay before starting the drx-onDurationTimer;
drx-InactivityTimer: the duration after the PDCCH occasion in which a PDCCH indicates a new UL or DL transmission for the MAC entity;
drx-RetransmissionTimerDL (per DL HARQ process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX Cycle starts;
drx-ShortCycle (optional): the Short DRX cycle;
drx-ShortCycleTimer (optional): the duration the UE shall follow the Short DRX cycle;
drx-HARQ-RTT-TimerDL (per DL HARQ process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity.

When a DRX cycle is configured, the Active Time includes the time while:
drx-onDurationTimer or drx-InactivityTimer or drx-RetransmissionTimerDL or drx-RetransmissionTimerUL or ra-ContentionResolutionTimer is running; or
a Scheduling Request is sent on the Physical Uplink Control Channel (PUCCH) and is pending; or
a Physical Downlink Control Channel (PDCCH) indicating a new transmission addressed to the Cell Radio Network Temporary Identifier (C-RNTI) of the Medium Access Control (MAC) entity has not been received after successful reception of a Random Access Response for the Random Access Preamble not selected by the MAC entity among the contention-based Random Access Preamble.

### UE Power Consumption in the Connected Mode

One challenging task to optimize the power consumption of user equipment (UE) during RRC_Connected mode is selecting the appropriate radio resource control (RRC) configurations. Taking the long-DRX cycle parameter of the CDRX configuration, for example, setting a large long-DRX cycle might bring advantage to the power consumption. This, however, might be at the cost of user-perceived throughput (UPT) degradation and the increase on the delay, which in some cases, might bring the UE to fall below the quality of service (QoS) requirements. On the other hand, setting a short long-DRX cycle might unnecessarily wake the UE up as there might be no data to be scheduled for the UE yet. Similar things also apply for the other parameter in the CDRX configurations, i.e., the inactivity timer (IAT), on-duration, etc. In general, setting inappropriate configurations might cause the UE to waste energy, e.g., by conducting unnecessary PDCCH monitoring.

Another example can be found in the configurations of the number of active serving cells (SCells). Activating too many SCells might cause one or more SCell active without having data to be scheduled on the respected SCell, and thus, wastes the UE energy. Activating too few SCells, on the other hand, might limit the UPT of the UE. In some cases though, activating too few SCells actually also brings drawback on the power consumption as the UE might remain in the inactivity timer longer, preventing the UE to enter the sleep part of the DRX cycle.

As we can see from the above explanations, setting up the UE with appropriate configurations will be very beneficial for the UE power consumption. Features that could help the network (NW) in determining the optimal configuration are therefore required.

To assist the NW in configuring the above parameters, some embodiments exploit a UE-based support mechanism, i.e., through UE assistance information (UAI). In this mechanism, the UE may send its preference for one or more RRC parameters, including one or more parameters related to DRX configuration, bandwidth (BW), the number of serving cells, etc. The limit on how frequent the UE can send UAI may be determined by the prohibit timer set by the NW for each UAI item. The NW, then, may configure the UE by the respected configurations whenever possible. It should be noted, however, the NW also has its own consideration before blindly following the configurations suggested by the UE.

Some embodiments introduce additional assistance information into the UAI procedures specified in Section 5.7.4 of 3GPP 38.331 v16.5.0. The example is for C-DRX UAI. Similar UAI procedures for other parameters can also be found in the same section.

### 5.7.4.2 Initiation

<text omitted>

Upon initiating the procedure, the UE shall:
<text omitted>
1> if configured to provide its preference on DRX parameters for power saving:
   2> if the UE did not transmit a UEAssistanceInformation message with drx-Preference since it was configured to provide its preference on DRX parameters for power saving; or
   2> if the current preference on DRX parameters is different from the one indicated in the last transmission of the UEAssistanceInformation message including drx-Preference and timer T346a is not running:
      3> start timer T346a with the timer value set to the drx-PreferenceProhibitTimer,
      3> initiate transmission of the UEAssistanceInformation message in accordance with 5.7.4.3 to provide its preference on DRX parameters for power saving;
<text omitted>
5.7.4.3 Actions related to transmission of UEAssistanceInformation message

The UE shall set the contents of the UEAssistanceInformation message as follows
<text omitted>
1> if transmission of the UEAssistanceInformation message is initiated to provide its preference on DRX parameters for power saving according to 5.7.4.2:
   2> include drx-Preference in the UEAssistanceInformation message;
   2> set preferredDRX-LongCycle to a desired value;
   2> set preferredDRX-InactivityTimerto a desired value;
   2> set preferredDRX-ShortCycle to a desired value;
   2> set preferredDRX-ShortCycleTimer to a desired value;

In addition to the above, below is the UAI information element captured in Section 6.2.2 of TS 38.331 v16.5.0.

The UEAssistanceInformation message is used for the indication of UE assistance information to the network.
Signalling radio bearer: SRB1
RLC-SAP: AM
Logical channel: DCCH
Direction: UE to Network

### UEAssistanceInformation Message

```
ASN1START
-- TAG-UEASSISTANCEINFORMATION-START
UEAssistanceInformation ::= SEQUENCE {
  criticalExtensions CHOICE {
    ueAssistanceInformation UEAssistanceInformation-IEs,
    criticalExtensionsFuture SEQUENCE { }
  }
}
UEAssistanceInformation-IEs ::= SEQUENCE {
  delayBudgetReport DelayBudgetReport OPTIONAL,
  lateNonCriticalExtension OCTET STRING OPTIONAL,
  nonCriticalExtension UEAssistanceInformation-v1540-IEs OPTIONAL
}
DelayBudgetReport::= CHOICE {
  type1 ENUMERATED {
      msMinus1280, msMinus640, msMinus320,
        msMinus160,msMinus80, msMinus60, msMinus40,
      msMinus20, ms0, ms20,ms40, ms60, ms80, ms160, ms320, ms640,
        ms1280},
  ...
}
UEAssistanceInformation-v1540-IEs ::= SEQUENCE {
  overheatingAssistance OverheatingAssistance OPTIONAL,
  nonCriticalExtension UEAssistanceInformation-v16xy-IEs OPTIONAL
}
OverheatingAssistance ::= SEQUENCE {
  reducedMaxCCs SEQUENCE {
    reducedCCsDL INTEGER (0..31),
    reducedCCsUL INTEGER (0..31)
  } OPTIONAL,
  reducedMaxBW-FR1 SEQUENCE {
    reducedBW-FR1-DL ReducedAggregatedBandwidth,
    reducedBW-FR1-UL ReducedAggregatedBandwidth
  } OPTIONAL,
  reducedMaxBW-FR2 SEQUENCE {
    reducedBW-FR2-DL ReducedAggregatedBandwidth,
    reducedBW-FR2-UL ReducedAggregatedBandwidth
  } OPTIONAL,
  reducedMaxMIMO-LayersFR1 SEQUENCE {
    reducedMIMO-LayersFR1-DL MIMO-LayersDL,
    reducedMIMO-LayersFR1-UL MIMO-LayersUL
  } OPTIONAL,
  reducedMaxMIMO-LayersFR2 SEQUENCE {
    reducedMIMO-LayersFR2-DL MIMO-LayersDL,
    reducedMIMO-LayersFR2-UL MIMO-LayersUL
  } OPTIONAL
}
ReducedAggregatedBandwidth ::= ENUMERATED {mhz0, mhz10, mhz20, mhz30, mhz40,
        mhz50, mhz60, mhz80, mhz100, mhz200, mhz300, mhz400}
UEAssistanceInformation-v16xy-IEs ::= SEQUENCE {
  idc-Assistance-asnr16 IDC-Assistance-r16 OPTIONAL,
  drx-Preference-r16 DRX-Preference-r16 OPTIONAL,
  maxBW-Preference-r16 MaxBW-Preference-r16 OPTIONAL,
  maxCC-Preference-r16 MaxCC-Preference-r16 OPTIONAL,
  maxMIMO-LayerPreference-r16 MaxMIMO-LayerPreference-r16 OPTIONAL,
  minSchedulingOffsetPreference-r16 MinSchedulingOffsetPreference-r16 OPTIONAL,
  releasePreference-r16 ReleasePreference-r16 OPTIONAL,
  sl-UE-AssistanceInformationNR-r16 SL-UE-AssistanceInformationNR-r16 OPTIONAL,
  nonCriticalExtension SEQUENCE { } OPTIONAL
}
IDC-Assistance-r16 ::= SEQUENCE {
affectedCarrierFreqList-r16 AffectedCarrierFreqList-r16 OPTIONAL,
affectedCarrierFreqCombList-r16 AffectedCarrierFreqCombList-r16 OPTIONAL,
  ...
}
AffectedCarrierFreqList-r16 ::= SEQUENCE (SIZE (1.. maxFreqIDC-r16)) OF
            AffectedCarrierFreq-r16
AffectedCarrierFreq-r16 ::= SEQUENCE {
  carrierFreq-r16 ARFCN-ValueNR,
  interferenceDirection-r16 ENUMERATED {nr, other, both, spare}
}
AffectedCarrierFreqCombList-r16 ::= SEQUENCE (SIZE (1..maxCombIDC-r16)) OF
          AffectedCarrierFreqComb-r16
AffectedCarrierFreqComb-r16 ::= SEQUENCE {
  affectedCarrierFreqComb-r16 SEQUENCE (SIZE (2..maxNrofServingCells)) OF ARFCN-
            ValueNR OPTIONAL,
  victimSystemType-r16 VictimSystemType-r16
}
VictimSystemType-r16 ::= SEQUENCE {
  gps-r16 ENUMERATED {true} OPTIONAL,
  glonass-r16 ENUMERATED {true} OPTIONAL,
  bds-r16 ENUMERATED {true} OPTIONAL,
  galileo-r16 ENUMERATED {true} OPTIONAL,
  navIC-r16 ENUMERATED {true} OPTIONAL,
  wlan-r16 ENUMERATED {true} OPTIONAL,
  bluetooth-r16 ENUMERATED {true} OPTIONAL,
  ...
}
DRX-Preference-r16 ::= SEQUENCE {
  preferredDRX-InactivityTimer-r16 ENUMERATED {
      ms0, ms1, ms2, ms3, ms4, ms5, ms6, ms8, ms10, ms20, ms30,
      ms40, ms50, ms60, ms80, ms100, ms200, ms300, ms500, ms750,
      ms1280, ms1920, ms2560, spare9, spare8, spare7, spare6, spare5,
      spare4, spare3, spare2, spare1} OPTIONAL,
  preferredDRX-LongCycle-r16 ENUMERATED {
      ms10, ms20, ms32, ms40, ms60, ms64, ms70, ms80, ms128,
      ms160, ms256, ms320, ms512, ms640, ms1024, ms1280, ms2048,
      ms2560, ms5120, ms10240, spare12, spare11, spare10, spare9,
      spare8, spare7, spare6, spare5, spare4, spare3, spare2, spare1 }
      OPTIONAL,
  preferredDRX-ShortCycle-r16 ENUMERATED {
      ms2, ms3, ms4, ms5, ms6, ms7, ms8, ms10, ms14, ms16, ms20,
      ms30, ms32, ms35, ms40, ms64, ms80, ms128, ms160, ms256,
      ms320, ms512, ms640, spare9, spare8, spare7, spare6, spare5,
      spare4, spare3, spare2, spare1 } OPTIONAL,
  preferredDRX-ShortCycleTimer-r16 INTEGER (1..16) OPTIONAL
}
MaxBW-Preference-r16 ::= SEQUENCE {
  reducedMaxBW-FR1-r16 SEQUENCE {
    reducedBW-FR1-DL-r16 ReducedAggregatedBandwidth,
    reducedBW-FR1-UL-r16 ReducedAggregatedBandwidth
  } OPTIONAL,
  reducedMaxBW-FR2-r16 SEQUENCE {
    reducedBW-FR2-DL-r16 ReducedAggregatedBandwidth,
    reducedBW-FR2-UL-r16 ReducedAggregatedBandwidth
  } OPTIONAL
}
MaxCC-Preference-r16 ::= SEQUENCE {
  reducedCCsDL-r16 INTEGER (0..31),
  reducedCCsUL-r16 INTEGER (0..31)
}
MaxMIMO-LayerPreference-r16 ::= SEQUENCE {
  reducedMaxMIMO-LayersFR1-r16 SEQUENCE {
    reducedMIMO-LayersFR1-DL-r16 INTEGER (1..8),
    reducedMIMO-LayersFR1-UL-r16 INTEGER (1..4)
  } OPTIONAL,
  reducedMaxMIMO-LayersFR2-r16 SEQUENCE {
    reducedMIMO-LayersFR2-DL-r16 INTEGER (1..8),
    reducedMIMO-LayersFR2-UL-r16 integer (1..4)
  } OPTIONAL
}
MinSchedulingOffsetPreference-r16 ::= SEQUENCE {
  preferredK0-r16 SEQUENCE {
    preferredK0-SCS-15kHz-r16 ENUMERATED {sl1, sl2, sl4, sl6} OPTIONAL,
    preferredK0-SCS-30kHz-r16 ENUMERATED {sl1, sl2, sl4, sl6} OPTIONAL,
    preferredK0-SCS-60kHz-r16 ENUMERATED {sl2, sl4, sl8, sl12} OPTIONAL,
    preferredK0-SCS-120kHz-r16 ENUMERATED {sl2, sl4, sl8, sl12} OPTIONAL
  } OPTIONAL,
  preferredK2-r16 SEQUENCE {
    preferredK2-SCS-15kHz-r16 ENUMERATED {sl1, sl2, sl4, sl6} OPTIONAL,
    preferredK2-SCS-30kHz-r16 ENUMERATED {sl1, sl2, sl4, sl6} OPTIONAL,
    preferredK2-SCS-60kHz-r16 ENUMERATED {sl2, sl4, sl8, sl12} OPTIONAL,
    preferredK2-SCS-120kHz-r16 ENUMERATED {sl2, sl4, sl8, sl12} OPTIONAL
  } OPTIONAL
}
ReleasePreference-r16 ::= SEQUENCE {
  preferredRRC-State-r16 ENUMERATED {idle, inactive, connected} OPTIONAL
}
SL-UE-AssistanceInformationNR-r16 ::= SEQUENCE (SIZE (1..maxNrofTrafficPattern-r16)) OF
TrafficPatternInfo-r16
TrafficPatternInfo-r16::= SEQUENCE {
  trafficPeriodicity-r16 ENUMERATED {
      ms20,ms50, ms100, ms200, ms300, ms400, ms500, ms600,
      ms700, ms800, ms900, ms1000},
  timingOffset-r16 INTEGER (0..10239) OPTIONAL,
  messageSize-r16 BIT STRING (SIZE (8)) OPTIONAL,
  sl-QoS-FlowIdentity-r16 SL-QoS-FlowIdentity-r16 OPTIONAL
}
-- TAG-UEASSISTANCEINFORMATION-STOP
ASN1STOP
```

In particular, some embodiments supplement the UAI above for DRX preference, e.g., in DRX-Preference-r16, as the existing DRX preference used for UE power saving heretofore only includes parameters related to short and long DRX cycles, inactivity timer (IAT), and short DRX cycle timer. While this preference provides a good tool for the UE to inform the NW about a power consumption friendly configuration for most applications, e.g., enhanced Mobile Broadband (eMBB), it heretofore does not provide a full set of parameters which are used to configure a C-DRX for the UE. According to embodiments herein, then, in UAI for DRX preference, the UE can recommend parameters such as drx-HARQ-RTT-TimerDL, drx-HARQ-RTT-TimerUL, drx-RetransmissionTimerDL, and rx-RetransmissionTimerUL.

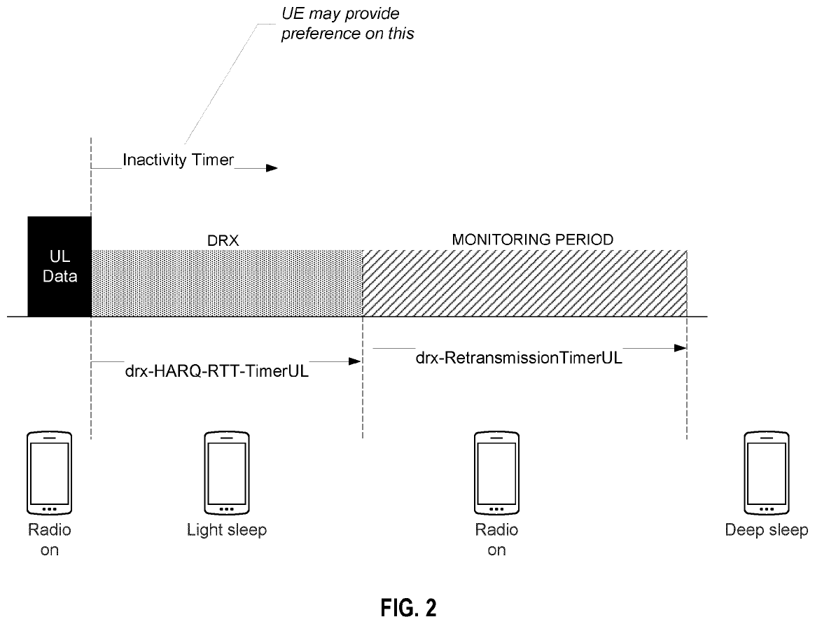

Some embodiments therefore advantageously prevent the following scenario. Heretofore, depending on the configuration of the said HARQ-RTT/Retransmission timers, the sum of these timers could be larger than the inactivity timer (IAT) and hence the period during which the UE cannot go into deeper sleep state could be longer than what the UE indicated as part of IAT preference. An uplink-related example is depicted in FIG. 2 in which the UE has provided preference on a short IAT based upon which the NW configured, but the UE cannot enjoy deep sleep state before drx-RetransmissionTimerUL has elapsed.

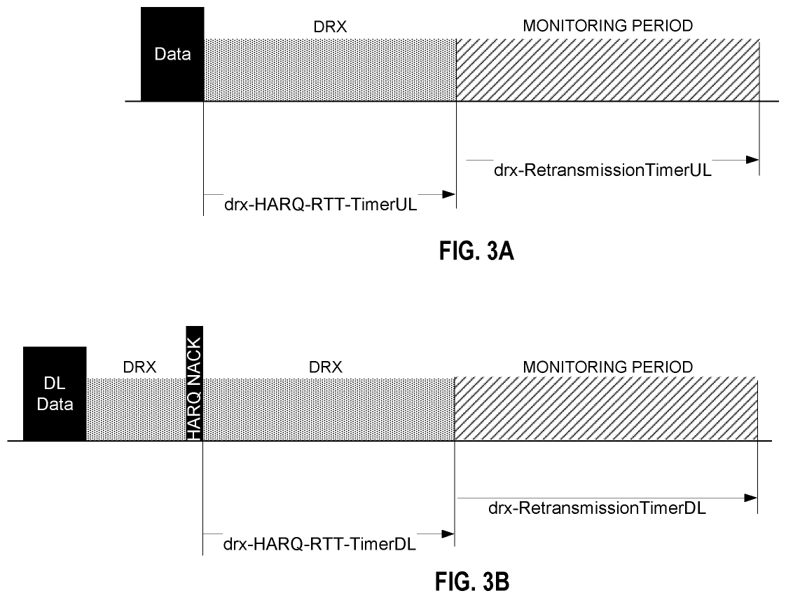

The mentioned parameters can have a significant impact on UE power consumption in applications which involve a higher level of UL communication such as eXtended Reality (XR) or interactive gaming. To explain this in more detail, the current specifications mandate the UE to listen for retransmission. These are controlled by the parameters drx-HARQ-RTT-TimerUL, drx-RetransmissionTimerUL, for UL and drx-HARQ-RTT-TimerDL, drx-RetransmissionTimerDL for DL respectively. FIGS. 3A-3B exemplify the cases in which the UE is monitoring the PDCCH in case a new retransmission is requested by the network for the UL transmission (FIG. 3A) and by the UE for the DL transmission (FIG. 3B). As it is shown, there will be a “monitoring period” during which the UE is listening to the DL control channel PDCCH. This monitoring period results in an increase of power consumption which would be in vain if there will not be any retransmissions.

In this context, some embodiments exploit the fact that the UE typically has a good knowledge about the traffic types and the channel conditions, and thus can help the NW to set the relevant parameters. Some embodiments therefore advantageously provide mechanisms which allow the UE to provide the relevant assistance information to the NW.

Some embodiments in this regard include methods and mechanisms with which the UE can provide UE assistance information such that the NW can configure the retransmission parameters in C-DRX configuration, namely drx-HARQ-RTT-TimerDL, drx-HARQ-RTT-TimerUL, drx-RetransmissionTimerDL, and drx-RetransmissionTimerUL, in a proper way.

Certain embodiments may provide one or more of the following technical advantage(s). Using the proposed approaches, the NW may acquire the UE preference to set the retransmission parameters in C-DRX such that the UE can save power while adhering to the delay and throughput constraint of specific applications, e.g., XR.

Herein a scenario is considered that the UE is configured with a C-DRX configuration which includes one or more of: a long or short DRX cycle, an inactivity timer, an onDuration timer, a short DRX timer, drx-HARQ-RTT-TimerUL, drx-RetransmissionTimerUL, drx-HARQ-RTT-TimerDL, and drx-RetransmissionTimerDL. Furthermore, it is assumed that such a UE can be configured with one or more UE assistance information (UAI), e.g., through higher layer signaling such that the UE can indicate its preference for one or more parameters in order to help the NW to determine one or more configurations. Specifically, the interest here is to develop UAI such that the UE can indicate its preference or provide assistance information to the NW, such that the NW can decide to determine parameters related to limitations on the retransmission timer within a C-DRX configuration, e.g., drx-HARQ-RTT-TimerUL, drx-RetransmissionTimerUL, drx-HARQ-RTT-TimerDL, drx-RetransmissionTimerDL, the maximum number of retransmissions, etc.

Below a number of mechanisms are disclosed to accommodate the above conditions.

### 1. UAI for Drx-HARQ-RTT-TimerUL, Drx-RetransmissionTimerUL, Drx-HARQ-RTT-TimerDL, Drx-RetransmissionTimerDL

Consider now some examples of C-DRX retransmission parameter preferences 24A shown in FIG. 1.

In one embodiment, the UE can be configured, e.g., through higher layer signaling, in order to indicate its preference regarding at least one of more of: drx-HARQ-RTT-TimerUL, drx-RetransmissionTimerUL, drx-HARQ-RTT-TimerDL, drx-RetransmissionTimerDL.

The UE can be further configured to be able to indicate the preference on the whole range of the available configurations for each parameter, or the UE can be configured additionally to only be able to provide the assistance information only for a range of potential configurations.

For example, the UE may be configured such that it is able to provide assistance information regarding the whole range of drx-RetransmissionTimerUL as follows:
drx-RetransmissionTimerUL ENUMERATED {sl0, sl1, sl2, sl4, sl6, sl8, sl16, sl24, sl33, sl40, sl64, sl80, sl96, sl112, sl128, sl160, sl320, spare15, spare14, spare13, spare12, spare11, spare10, spare9, spare8, spare7, spare6, spare5, spare4, spare3, spare2, spare1}.

Or, as another example, the UE can only provide the following preferences:
drx-RetransmissionTimerUL ENUMERATED {sl0, sl1, sl2, sl4, sl6, sl8, sl16},

In one example, the UE may indicate the UAI from all possible preference values configured for the UE (either by standard or by the NW). Here, the UE may send a preferred value that is either larger or smaller than the currently configured value for the UE.

In another example, the UE may only indicate a preferred value that is smaller than the currently configured value for the UE. For example, if the UE is currently configured by the NW with a drx-RetransmissionTimerUL value of sl16, the UE may only be allowed to indicate the preference value for sl0, sl1, . . . , sl8. The reasoning is that the UE may only use the UAI to inform the NW that the UE needs to reduce the value of the currently configured value, e.g., to save power or to satisfy some QoS requirements.

In some embodiments, the UE may be configured such that it is only allowed to indicate the preference for one or more of the retransmission parameters only if the UE additionally is configured with one more UAI, e.g., DRX-preference. Alternatively, the UE may be configured to be able to indicate its preference for one or more of the retransmission parameters from the other DRX-preference parameters, e.g., as in Rel 16.

In another embodiment, the NW may only allow the UE to provide assistance on the DL related timers. As such, the UE can inform the NW for how long the UE is willing to wait for a NW retransmission. Perhaps the UE prefers to continue with the next transmission/packet rather than delaying the service and getting stuck with retransmission efforts on an outdated packet.

The UE may be additionally configured with a prohibition timer such that the UE is not allowed to indicate its preference for one or more of the retransmission timers before the prohibition timer is expired. For example, the UE may be configured with a prohibition timer of 30 seconds, and thus the UE cannot indicate its preference, e.g., for drx-RetransmissionTimerUL, before 30 seconds is expired, e.g., from the last time that the UE has indicated its preference.

In a related realization, the prohibition timer can be set differently for one or more of the retransmission parameters from the rest of the DRX-preference parameters. This can be useful, e.g., in applications where the UL traffic change is more dynamic, and thus it makes sense that the UE is able to indicate its preference more often for one of the retransmission parameters than other C-DRX configuration parameters.

### 2. UAI for Maximum Number of Retransmissions

Consider now some other examples of C-DRX retransmission parameter preferences 24A shown in FIG. 1.

In one embodiment, the UE can be configured, e.g., through higher layer signaling, in order to indicate its preference regarding the maximum number of retransmissions the UE prefers in UL and/or DL. For example, the UE may provide the following preferences:
maxNbrPreferredReTx_DL ENUMERATED {n0, n1, n2, . . . n16}
   where n0 means that the UE is not interested in receiving any retransmissions, n1 indicates that the UE is interested in a single retransmission only, and so on.

In one aspect, if the NW agrees with the UE preferred parameter, the UE may be allowed to omit provision of UL HARQ feedback on the last received (re)transmission. For example, if n2 from the example above is agreed between the NW and the UE, then the UE omits the UL PUCCH HARQ feedback on the second retransmission.

In another embodiment, the NW may only allow the UE to provide assistance on the DL related parameter. As such, the UE can inform the NW for how long the UE is willing to wait for total NW retransmissions related to a transmission. Perhaps the UE prefers to continue with the next transmission/packet rather than delaying the service and getting stuck with retransmission efforts on an outdated packet.

Similar to the DRX parameters mentioned earlier, here, the UE may be additionally configured with a prohibition timer such that the UE is not allowed to indicate its preference for one or more flows/DRBs before the prohibition timer is expired.

### 3. UAI for Maximum Retransmission Total Duration

Consider next some more examples of C-DRX retransmission parameter preferences 24A shown in FIG. 1.

In another embodiment, the UAI may also be in terms of a maximum of total duration (e.g., in slots, ms, etc.), in which the UE is still OK to receive retransmission. For example, this is because retransmission exceeds such total duration may anyway already dissatisfy the QoS requirement or application requirement. In one example, the maximum retransmission total duration can be counted from the slot or symbol in which the UE receives the PDCCH scheduling the DL/UL transmission to the symbol or slot in which the UE prefers not to receive anymore retransmission.

This value, in one example, can be used by the NW to determine the values of drx-HARQ-RTT-TimerUL, drx-RetransmissionTimerUL, drx-HARQ-RTT-TimerDL, drx-RetransmissionTimerDL and/or the maximum number of retransmission agreed by the UE and the NW. For example, based on the UE's preferred maximum total retransmission duration, the NW may configure the UE with a relatively wide retransmission window and a relatively small number of maximum number of retransmission; or the NW may configure the UE with a relatively narrow retransmission window and a relatively large number of maximum number of retransmission, i.e., to achieve the same maximum retransmission duration. The first configuration can be selected, for example, for the case of the NW is not in a high load but the UE is in relatively bad channel quality link. The second configuration can be selected, for example, for the case of the NW the UE is in a high load but the UE is in a good coverage.

### 4. UAI for Different QoS Flows/DRBs

In this aspect, the UE is configured to be able to provide a set of preferences relevant for different QoS Flows or DRBs. For example, assume that the NW has configured the UE with multiple flows running in parallel, but these flows might have different characteristics (e.g., packet error rate, delay budget, etc.). As such, the UE may have different preferences for the retransmission parameters mentioned in earlier sections associated with the different flows.

In one embodiment, the NW might have configured the UE to only provide preference on a subset of configured flows and/or the default DRB.

Based on the UE preferences for the different flows/DRB, the NW may then configure the UE with multiple sets of said timers/retransmission counters and activate one of them at a time explicitly (e.g., via Downlink Control Information, DCI) per transmission or implicitly (e.g., if only one flow out of earlier two is still active). Such indication may be either via DCI associated with the assignment/grant pointing out which of the retransmission parameters that are applicable for current (re)transmission or semi-statically activated by for example MAC Control Element (MAC-CE) or DCI, meaning that the parameters pointed out by the semi-static indication remain applicable for ongoing/upcoming (re)transmissions until further notice, e.g., until another configuration is activated, or unless a specific transmission's DCI says otherwise.

For example, assume that the NW has configured the UE (optionally based on earlier received UAI) with two sets of retransmissions-related parameters (mentioned earlier); paramSet1 and paramSet2. When a DL transmission is related to a first flow, the NW may indicate in the DCI that paramSet1 is applicable to this transmission whereby the UE handles the transmission with the associated timers/counters (timers and counters of aspects 1&2) according to paramSet1 configuration. In another transmission, the NW indicates in the DCI that configuration from ParamSet2 is applicable instead whereby the UE handles that transmission accordingly.

### 5. UAI for Redundant Retransmission

Consider now some examples of C-DRX retransmission metric value(s) 24B shown in FIG. 1.

In another embodiment, a UE may indicate statistical information related to redundant waiting time for retransmission so that a network can adjust or optimize all DRX parameters. As a non-limiting example, a UE can report total or average amount of time that a UE monitors PDDCH for retransmission that did not have any actual retransmission. This value can be estimated during over a certain time window and also can be defined in a relative manner, e.g., the port of redundant waiting time for retransmission over an entire wake-up time. As this value gets higher and higher, it means that a UE wastes energy more and more. This will tell a network to consider the possibility to set a lower value of drx-RetransmissionTimerUL further to save UE energy. A UE can also report the increase or decrease of redundant waiting time for retransmission so that a network can also recognize a trend. This information can be also implicitly obtained by a network estimation which may be less accurate than an explicit UE report.

### 6. UAI of Traffic Information to a gNB

Consider next some examples of C-DRX traffic metric value(s) 24C shown in FIG. 1.

In some embodiments, a UE can report traffic specific information to a gNB together possibly with more information not included in side-link traffic information. Examples of reported information to a gNB directly include delay budget, traffic arrival periodicity, jitter, a packet size, QoS flow ID, or buffer size. Those values can be defined as the maximum, the minimum, or average value from a statistics collected during a measured time duration.

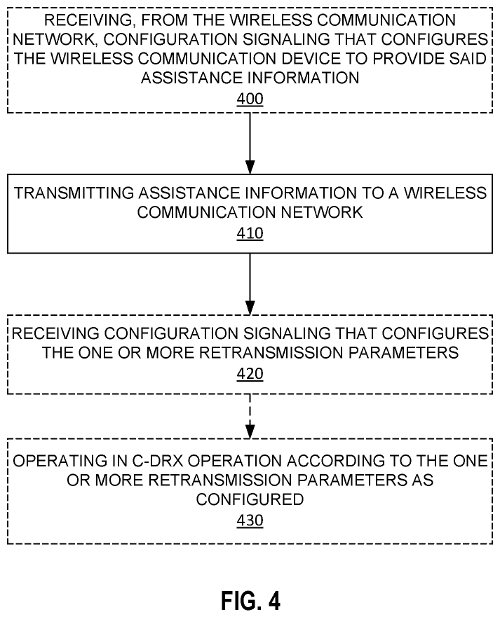

In view of the modifications and variations herein, FIG. 4 depicts a method performed by a wireless communication device 12 configured for use in a wireless communication network 10 in accordance with particular embodiments. The method includes transmitting, to a wireless communication network 10, assistance information 24 (Block 410). In some embodiments, the assistance information 24 indicates a preference 24A of the wireless communication device 12 for each of one or more retransmission parameters 22 that control retransmission in connected mode discontinuous reception, C-DRX, operation. Alternatively or additionally, the assistance information 24 may indicate a value 24B measured by the wireless communication device 12 for each of one or more retransmission metrics that describe retransmission in C-DRX operation. Alternatively or additionally, the assistance information 24 may indicate a value 24C measured by the wireless communication device 12 for each of one or more traffic metrics that describe uplink or downlink data traffic in C-DRX operation.

In some embodiments, the method further comprises receiving configuration signaling that configures the one or more retransmission parameters 22 (Block 420). Regardless, in one or more such embodiments, the method may comprise operating in C-DRX operation according to the one or more retransmission parameters as configured (Block 430).

In some embodiments, the method also comprises receiving, from the wireless communication network, configuration signaling that configures the wireless communication device to provide said assistance information 24 (Block 400).

In some embodiments, the assistance information indicates a preference of the wireless communication device for each of one or more retransmission parameters that control retransmission in C-DRX operation.

In some embodiments, at least one of the one or more retransmission parameters controls a timing of retransmission in C-DRX operation. Additionally or alternatively, at least one of the one or more retransmission parameters controls a timing of control signaling for controlling retransmission in C-DRX operation.

In some embodiments, the one or more retransmission parameters include one or more of a downlink retransmission timer that controls a maximum duration until a downlink retransmission is received, an uplink retransmission timer that controls a maximum duration until a grant for an uplink retransmission is received, a downlink hybrid automatic repeat request, HARQ, round-trip time timer that controls a minimum duration before a downlink assignment for HARQ retransmission is expected by a medium access control, MAC, entity, and an uplink HARQ round-trip time timer that controls a minimum duration before an uplink HARQ retransmission grant is expected by a MAC entity.

In some embodiments, at least one of the one or more retransmission parameters controls a maximum number of uplink and/or downlink retransmissions in C-DRX operation.

In some embodiments, at least one of the one or more retransmission parameters controls a maximum window of time within which any retransmission of an original transmission is transmittable since the original transmission was transmitted or scheduled.

In some embodiments, the assistance information provides one or more preferred values for the one or more retransmission parameters, respectively.

In some embodiments, the assistance information indicates a value measured by the wireless communication device for each of one or more retransmission metrics that describe retransmission in C-DRX operation.

In some embodiments, at least one of the one or more retransmission metrics describes an amount of time that the wireless communication device has monitored for a retransmission that never came. In one or more of these embodiments, the at least one of the one or more retransmission metrics indicates the amount of time absolutely, indicates the amount of time as a portion of a wake-up time, or indicates whether the amount of time is increasing or decreasing over time. In one or more of these embodiments, the amount of time is the average amount of time that the wireless communication device has monitored for a retransmission that never came. In one or more of these embodiments, at least one of the one or more retransmission metrics is a statistical metric.

In some embodiments, the assistance information indicates a value measured by the wireless communication device for each of one or more traffic metrics that describe uplink or downlink data traffic in C-DRX operation.

In some embodiments, at least one of the one or more traffic metrics indicates a delay budget for uplink or downlink data traffic in C-DRX operation, a traffic arrival periodicity for uplink or downlink data traffic in C-DRX operation, a jitter for uplink or downlink data traffic in C-DRX operation, a packet size for uplink or downlink data traffic in C-DRX operation, a quality of service flow identifier for uplink or downlink data traffic in C-DRX operation, or a buffer size for uplink or downlink data traffic in C-DRX operation. In one or more of these embodiments, the at least one of the one or more traffic metrics is a statistical metric.

In some embodiments, the assistance information comprises assistance information specific for each of one or more quality of service flows or data radio bearers.

In some embodiments, the assistance information is user equipment, UE, assistance information, UAI.

In some embodiments, the method further comprises receiving, from the wireless communication network, configuration signaling that configures, for at least one retransmission parameter of the one or more retransmission parameters, a set of values from which the wireless communication device is allowed to provide a preferred value for the at least one retransmission parameter. In one or more of these embodiments, the set of values is a proper subset of a set of allowed values. In one or more of these embodiments, the proper subset includes one or more values that are smaller than a value currently configured for the at least one retransmission parameter.

In some embodiments, the method further comprises, upon transmitting the assistance information, starting a prohibit timer that, while the prohibit timer is running, prohibits the transmission of assistance information which provides a preference of the wireless communication device on any of the one or more retransmission parameters or assistance information which provides a preference of the wireless communication device on a subset of the one or more retransmission parameters.

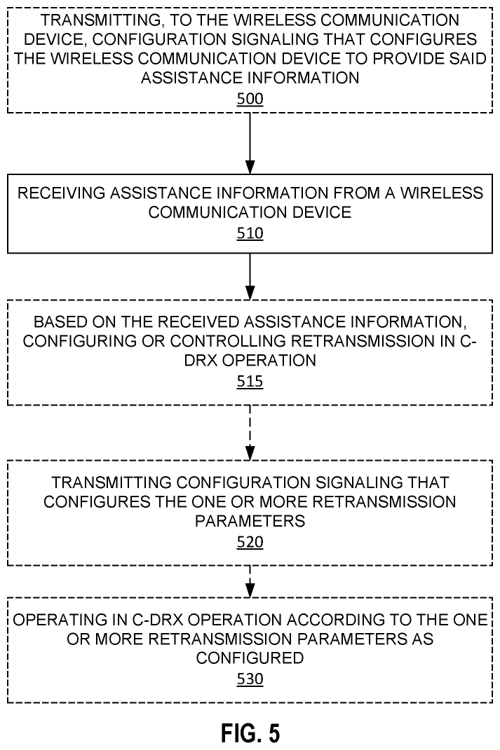

FIG. 5 depicts a method performed by a network node configured for use in a wireless communication network in accordance with other particular embodiments. The method includes receiving, from a wireless communication device 12, assistance information 24 (Block 510). In some embodiments, the assistance information 24 indicates a preference 24A of the wireless communication device 12 for each of one or more retransmission parameters 22 that control retransmission in connected mode discontinuous reception, C-DRX, operation. Alternatively or additionally, the assistance information 24 may indicate a value 24B measured by the wireless communication device 12 for each of one or more retransmission metrics that describe retransmission in C-DRX operation. Alternatively or additionally, the assistance information 24 may indicate a value 24C measured by the wireless communication device 12 for each of one or more traffic metrics that describe uplink or downlink data traffic in C-DRX operation.

In some embodiments, the method also comprises, based on the received assistance information 24, configuring or controlling retransmission in C-DRX operation (Block 515). For example, such may involve configuring one or more retransmission parameters 22 that control retransmission in C-DRX operation.

In some embodiments, the method further comprises transmitting configuration signaling that configures the one or more retransmission parameters 22 (Block 520). In one or more such embodiments, the method may comprise operating in C-DRX operation according to the one or more retransmission parameters as configured (Block WW330).

In some embodiments, the method also comprises transmitting, to the wireless communication device 12, configuration signaling that configures the wireless communication device 12 to provide said assistance information 24 (Block WW300).

In some embodiments, the assistance information indicates a preference of the wireless communication device for each of one or more retransmission parameters that control retransmission in C-DRX operation.

In some embodiments, at least one of the one or more retransmission parameters controls a timing of retransmission in C-DRX operation. Additionally or alternatively, at least one of the one or more retransmission parameters controls a timing of control signaling for controlling retransmission in C-DRX operation.

In some embodiments, the one or more retransmission parameters include one or more of a downlink retransmission timer that controls a maximum duration until a downlink retransmission is received, an uplink retransmission timer that controls a maximum duration until a grant for an uplink retransmission is received, a downlink hybrid automatic repeat request, HARQ, round-trip time timer that controls a minimum duration before a downlink assignment for HARQ retransmission is expected by a medium access control, MAC, entity, and an uplink HARQ round-trip time timer that controls a minimum duration before an uplink HARQ retransmission grant is expected by a MAC entity.

In some embodiments, wherein at least one of the one or more retransmission parameters controls a maximum number of uplink and/or downlink retransmissions in C-DRX operation.

In some embodiments, at least one of the one or more retransmission parameters controls a maximum window of time within which any retransmission of an original transmission is transmittable since the original transmission was transmitted or scheduled.

In some embodiments, the assistance information provides one or more preferred values for the one or more retransmission parameters, respectively.

In some embodiments, the assistance information indicates a value measured by the wireless communication device for each of one or more retransmission metrics that describe retransmission in C-DRX operation.

In some embodiments, at least one of the one or more retransmission metrics describes an amount of time that the wireless communication device has monitored for a retransmission that never came. In one or more of these embodiments, the at least one of the one or more retransmission metrics indicates the amount of time absolutely, indicates the amount of time as a portion of a wake-up time, or indicates whether the amount of time is increasing or decreasing over time. In one or more of these embodiments, the amount of time is the average amount of time that the wireless communication device has monitored for a retransmission that never came. In one or more of these embodiments, at least one of the one or more retransmission metrics is a statistical metric.

In some embodiments, the assistance information indicates a value measured by the wireless communication device for each of one or more traffic metrics that describe uplink or downlink data traffic in C-DRX operation.

In some embodiments, at least one of the one or more traffic metrics indicates a delay budget for uplink or downlink data traffic in C-DRX operation, a traffic arrival periodicity for uplink or downlink data traffic in C-DRX operation, a jitter for uplink or downlink data traffic in C-DRX operation, a packet size for uplink or downlink data traffic in C-DRX operation, a quality of service flow identifier for uplink or downlink data traffic in C-DRX operation, or a buffer size for uplink or downlink data traffic in C-DRX operation. In one or more of these embodiments, the at least one of the one or more traffic metrics is a statistical metric.

In some embodiments, the assistance information comprises assistance information specific for each of one or more quality of service flows or data radio bearers.

In some embodiments, the assistance information is user equipment, UE, assistance information, UAI.

In some embodiments, the method further comprises transmitting, to the wireless communication device, configuration signaling that configures, for at least one retransmission parameter of the one or more retransmission parameters, a set of values from which the wireless communication device is allowed to provide a preferred value for the at least one retransmission parameter. In one or more of these embodiments, the set of values is a proper subset of a set of allowed values. In one or more of these embodiments, the proper subset includes one or more values that are smaller than a value currently configured for the at least one retransmission parameter.

In some embodiments, the method further comprises transmitting, to the wireless communication device, configuration signaling that configures a value of a prohibit timer of the wireless communication device. While the prohibit timer is running at the wireless communication device, the prohibits the transmission of assistance information which provides a preference of the wireless communication device on any of the one or more retransmission parameters, or assistance information which provides a preference of the wireless communication device on a subset of the one or more retransmission parameters. In some embodiments, the method further comprises based on the received assistance information, configuring or controlling retransmission in C-DRX operation. In one or more of these embodiments, configuring or controlling comprises configuring one or more retransmission parameters that control retransmission in C-DRX operation. In one or more of these embodiments, configuring one or more retransmission parameters comprises configuring one or more of a downlink retransmission timer that controls a maximum duration until a downlink retransmission is received, an uplink retransmission timer that controls a maximum duration until a grant for an uplink retransmission is received, a downlink hybrid automatic repeat request, HARQ, round-trip time timer that controls a minimum duration before a downlink assignment for HARQ retransmission is expected by a medium access control, MAC, entity, and an uplink HARQ round-trip time timer that controls a minimum duration before an uplink HARQ retransmission grant is expected by a MAC entity. In one or more of these embodiments, the assistance information comprises assistance information specific for each of one or more quality of service, QoS, flows or data radio bearers, DRBs. In this case, configuring one or more retransmission parameters that control retransmission in C-DRX operation comprises, for each of the one or more QoS flows or DRBs, configuring a respective set of one or more retransmission parameters that is specific to that QoS flow or DRB, and the method further comprises transmitting signaling that indicates which set of one or more retransmission parameters is active. In one or more of these embodiments, the assistance information comprises assistance information specific for each of multiple quality of service, QoS, flows or data radio bearers, DRBs. In this case, the method further comprises configuring the wireless communication device with multiple sets of one or more transmission parameters that control retransmission in C-DRX operation and that are specific to respective ones of the multiple QoS flows or DRBs. In one or more of these embodiments, the method further comprises dynamically or semi-statically activating a set of one or more transmission parameters, from the multiple sets of one or more transmission parameters, for a transmission associated with the QoS flow or DRB specific to that set. In one or more of these embodiments, activating comprises transmitting, in a grant or assignment scheduling the transmission, explicit signaling that activates the set.

Embodiments herein also include corresponding apparatuses. Embodiments herein for instance include a wireless communication device 12 configured to perform any of the steps of any of the embodiments described above for the wireless communication device 12.

Embodiments also include a wireless communication device 12 comprising processing circuitry and power supply circuitry. The processing circuitry is configured to perform any of the steps of any of the embodiments described above for the wireless communication device 12. The power supply circuitry is configured to supply power to the wireless communication device 12.

Embodiments further include a wireless communication device 12 comprising processing circuitry. The processing circuitry is configured to perform any of the steps of any of the embodiments described above for the wireless communication device 12. In some embodiments, the wireless communication device 12 further comprises communication circuitry.

Embodiments further include a wireless communication device 12 comprising processing circuitry and memory. The memory contains instructions executable by the processing circuitry whereby the wireless communication device 12 is configured to perform any of the steps of any of the embodiments described above for the wireless communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 14 configured to perform any of the steps of any of the embodiments described above for the wireless communication network 10.

Embodiments also include a network node 14 comprising processing circuitry and power supply circuitry. The processing circuitry is configured to perform any of the steps of any of the embodiments described above for the wireless communication network 10. The power supply circuitry is configured to supply power to the network node 14.

Embodiments further include a network node 14 comprising processing circuitry. The processing circuitry is configured to perform any of the steps of any of the embodiments described above for the wireless communication network 10. In some embodiments, the network node 14 further comprises communication circuitry.

Embodiments further include a network node 14 comprising processing circuitry and memory. The memory contains instructions executable by the processing circuitry whereby the network node 14 is configured to perform any of the steps of any of the embodiments described above for the wireless communication network 10.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

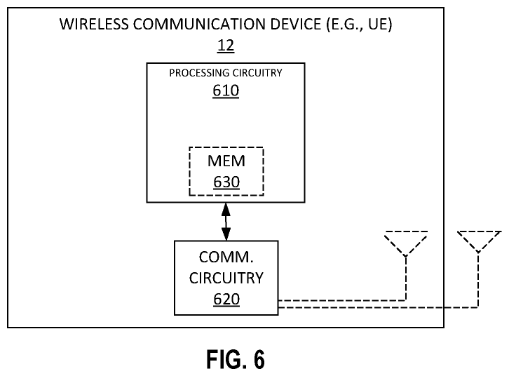

FIG. 6 for example illustrates a wireless communication device 12 as implemented in accordance with one or more embodiments. As shown, the wireless communication device 12 includes processing circuitry 610 and communication circuitry 620. The communication circuitry 620 (e.g., radio circuitry) is configured to transmit and/or receive information to and/or from one or more other nodes, e.g., via any communication technology. Such communication may occur via one or more antennas that are either internal or external to the wireless communication device 12. The processing circuitry 610 is configured to perform processing described above, e.g., in FIG. 4, such as by executing instructions stored in memory 630. The processing circuitry 610 in this regard may implement certain functional means, units, or modules.

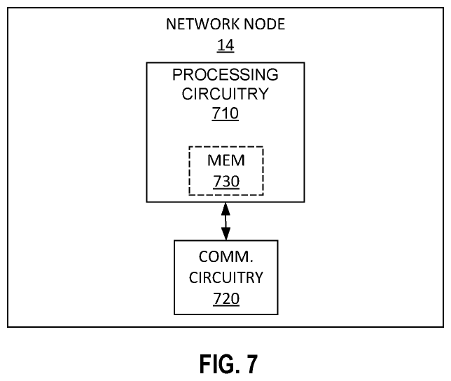

FIG. 7 illustrates a network node 14 as implemented in accordance with one or more embodiments. As shown, the network node 14 includes processing circuitry 710 and communication circuitry 720. The communication circuitry 720 is configured to transmit and/or receive information to and/or from one or more other nodes, e.g., via any communication technology. The processing circuitry 710 is configured to perform processing described above, e.g., in FIG. 5, such as by executing instructions stored in memory 730. The processing circuitry 710 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

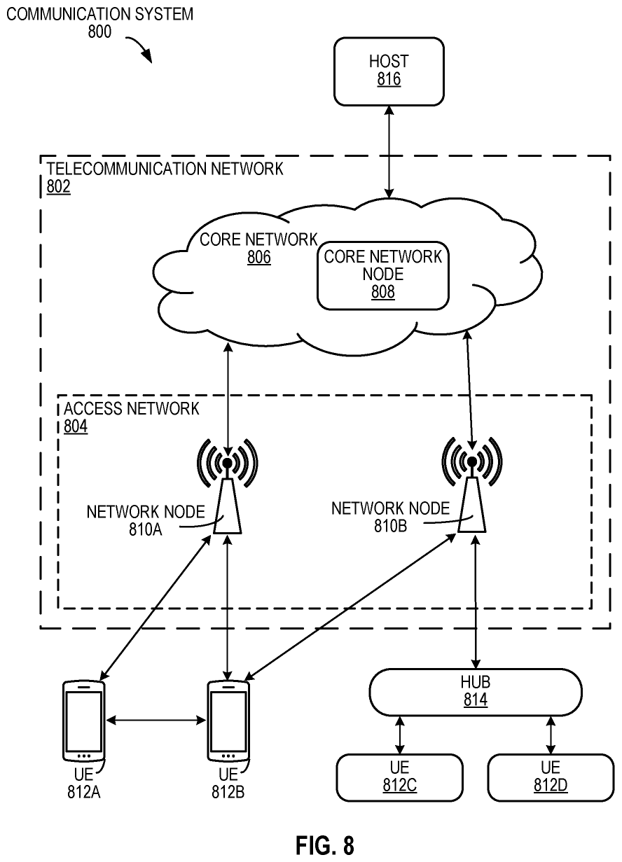

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3rd Generation Partnership Project (3GPP) access node or non-3GPP access point. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

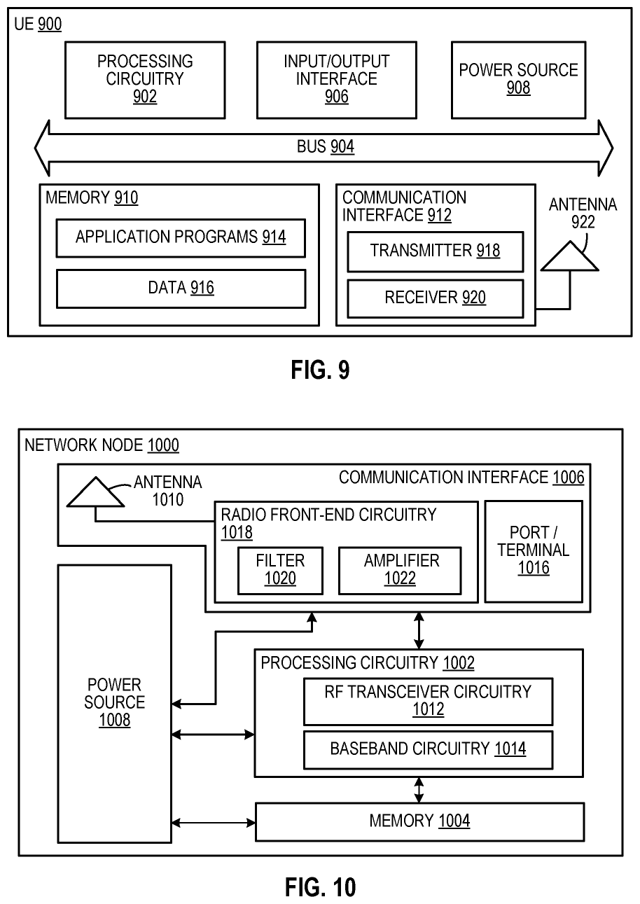

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-loT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

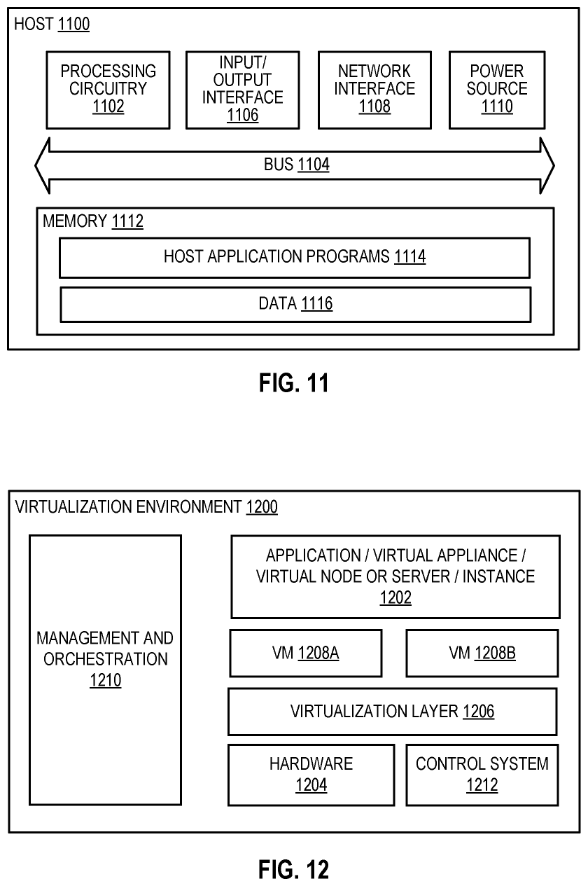

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

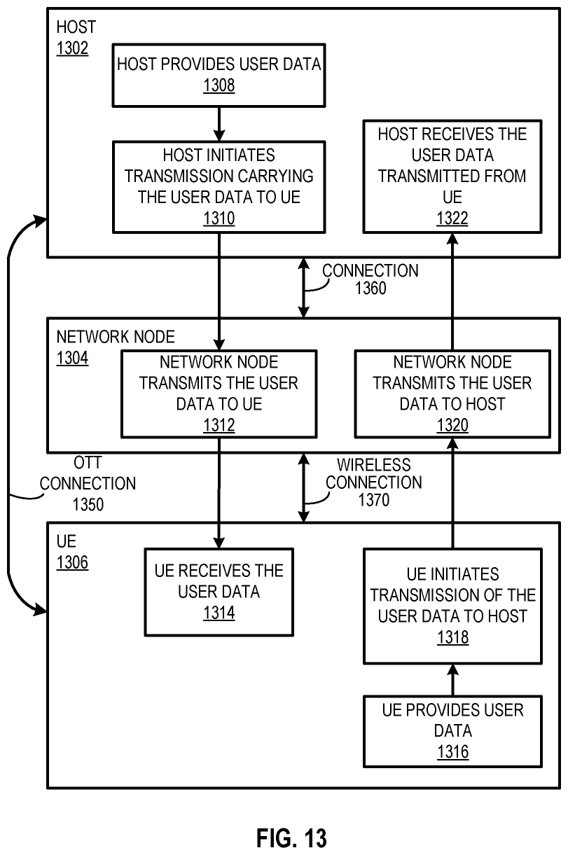

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and 10 initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The term “A and/or B” as used herein covers embodiments having A alone, B alone, or both A and B together. The term “A and/or B” may therefore equivalently mean “at least one of any one or more of A and B”.

Example embodiments of the techniques and apparatus described herein include, but are not limited to, the following enumerated examples:

### Group A Embodiments

A1. A method performed by a wireless communication device, the method comprising:
transmitting, to a wireless communication network, assistance information indicating:
   a preference of the wireless communication device for each of one or more retransmission parameters that control retransmission in connected mode discontinuous reception, C-DRX, operation;
   a value measured by the wireless communication device for each of one or more retransmission metrics that describe retransmission in C-DRX operation; and/or
   a value measured by the wireless communication device for each of one or more traffic metrics that describe uplink or downlink data traffic in C-DRX operation.

A2. The method of embodiment A1, wherein the assistance information indicates a preference of the wireless communication device for each of one or more retransmission parameters that control retransmission in C-DRX operation.

A3. The method of any of embodiments A1-A2, wherein at least one of the one or more retransmission parameters controls a timing of retransmission in C-DRX operation and/or a timing of control signaling for controlling retransmission in C-DRX operation.

A4. The method of any of embodiments A1-A3, wherein the one or more retransmission parameters include one or more of:
a downlink retransmission timer that controls a maximum duration until a downlink retransmission is received;
an uplink retransmission timer that controls a maximum duration until a grant for an uplink retransmission is received;
a downlink hybrid automatic repeat request, HARQ, round-trip time timer that controls a minimum duration before a downlink assignment for HARQ retransmission is expected by a medium access control, MAC, entity; and
an uplink HARQ round-trip time timer that controls a minimum duration before an uplink HARQ retransmission grant is expected by a MAC entity.

A5. The method of any of embodiments A1-A4, wherein at least one of the one or more retransmission parameters controls a maximum number of uplink and/or downlink retransmissions in C-DRX operation.

A6. The method of any of embodiments A1-A5, wherein at least one of the one or more retransmission parameters controls a maximum window of time within which any retransmission of an original transmission is transmittable since the original transmission was transmitted or scheduled.

A7. The method of any of embodiments A1-A6, wherein the assistance information provides one or more preferred values for the one or more retransmission parameters, respectively.

A8. The method of any of embodiments A1-A7, wherein the assistance information indicates a value measured by the wireless communication device for each of one or more retransmission metrics that describe retransmission in C-DRX operation.

A9. The method of any of embodiments A1-A8, wherein at least one of the one or more retransmission metrics describes an amount of time that the wireless communication device has monitored for a retransmission that never came or an amount of time that the wireless communication device has monitored for an assignment or grant, for a retransmission, that never came.

A10. The method of embodiment A9, wherein the at least one of the one or more retransmission metrics indicates the amount of time absolutely, indicates the amount of time as a portion of a wake-up time, or indicates whether the amount of time is increasing or decreasing over time.

A11. The method of any of embodiments A9-A10, wherein the amount of time is the average amount of time that the wireless communication device has monitored for a retransmission that never came.

A12. The method of any of embodiments A9-A11, wherein at least one of the one or more retransmission metrics is a statistical metric.

A13. The method of any of embodiments A1-A12, wherein the assistance information indicates a value measured by the wireless communication device for each of one or more traffic metrics that describe uplink or downlink data traffic in C-DRX operation.

A14. The method of any of embodiments A1-A13, wherein at least one of the one or more traffic metrics indicates:
a delay budget for uplink or downlink data traffic in C-DRX operation;
a traffic arrival periodicity for uplink or downlink data traffic in C-DRX operation;
a jitter for uplink or downlink data traffic in C-DRX operation;
a packet size for uplink or downlink data traffic in C-DRX operation;
a quality of service flow identifier for uplink or downlink data traffic in C-DRX operation; or
a buffer size for uplink or downlink data traffic in C-DRX operation.

A15. The method of embodiment A14, wherein the at least one of the one or more traffic metrics is a statistical metric.

A16. The method of any of embodiments A1-A15, wherein the assistance information comprises assistance information specific for each of one or more quality of service flows or data radio bearers.

A17. The method of any of embodiments A1-A16, wherein the assistance information is user equipment, UE, assistance information, UAI.

A18. The method of any of embodiments A1-A17, further comprising receiving, from the wireless communication network, configuration signaling that configures the wireless communication device to provide said assistance information.

A19. The method of any of embodiments A1-A18, further comprising receiving, from the wireless communication network, configuration signaling that configures, for at least one retransmission parameter of the one or more retransmission parameters, a set of values from which the wireless communication device is allowed to provide a preferred value for the at least one retransmission parameter.

A20. The method of embodiment A19, wherein the set of values is a proper subset of a set of allowed values.

A21. The method of embodiment A20, wherein the proper subset includes one or more values that are smaller than a value currently configured for the at least one retransmission parameter.

A22. The method of any of embodiments A1-A21, further comprising, upon transmitting the assistance information, starting a prohibit timer that, while the prohibit timer is running, prohibits the transmission of:
assistance information which provides a preference of the wireless communication device on any of the one or more retransmission parameters; or
assistance information which provides a preference of the wireless communication device on a subset of the one or more retransmission parameters.

A23. The method of any of embodiments A1-A22, further comprising receiving configuration signaling that configures the one or more retransmission parameters.

A24. The method of embodiment A23, further comprising operating in C-DRX operation according to the one or more retransmission parameters as configured.

AA. The method of any of the previous embodiments, further comprising:
providing user data; and
forwarding the user data to a host via the transmission to the network node.

### Group B Embodiments

B1. A method performed by a network node configured for use in a wireless communication network, the method comprising:
receiving, from a wireless communication device, assistance information indicating:
   a preference of the wireless communication device for each of one or more retransmission parameters that control retransmission in connected mode discontinuous reception, C-DRX, operation;
   a value measured by the wireless communication device for each of one or more retransmission metrics that describe retransmission in C-DRX operation; and/or
   a value measured by the wireless communication device for each of one or more traffic metrics that describe uplink or downlink data traffic in C-DRX operation.

B2. The method of embodiment 1, wherein the assistance information indicates a preference of the wireless communication device for each of one or more retransmission parameters that control retransmission in C-DRX operation.

B3. The method of any of embodiments B1-B2, wherein at least one of the one or more retransmission parameters controls a timing of retransmission in C-DRX operation and/or a timing of control signaling for controlling retransmission in C-DRX operation.

B4. The method of any of embodiments B1-B3, wherein the one or more retransmission parameters include one or more of:
a downlink retransmission timer that controls a maximum duration until a downlink retransmission is received;
an uplink retransmission timer that controls a maximum duration until a grant for an uplink retransmission is received;
a downlink hybrid automatic repeat request, HARQ, round-trip time timer that controls a minimum duration before a downlink assignment for HARQ retransmission is expected by a medium access control, MAC, entity; and
an uplink HARQ round-trip time timer that controls a minimum duration before an uplink HARQ retransmission grant is expected by a MAC entity.

B5. The method of any of embodiments B1-B4, wherein at least one of the one or more retransmission parameters controls a maximum number of uplink and/or downlink retransmissions in C-DRX operation.

B6. The method of any of embodiments B1-B5, wherein at least one of the one or more retransmission parameters controls a maximum window of time within which any retransmission of an original transmission is transmittable since the original transmission was transmitted or scheduled.

B7. The method of any of embodiments B1-B6, wherein the assistance information provides one or more preferred values for the one or more retransmission parameters, respectively.

B8. The method of any of embodiments B1-B7, wherein the assistance information indicates a value measured by the wireless communication device for each of one or more retransmission metrics that describe retransmission in C-DRX operation.

B9. The method of any of embodiments B1-B8, wherein at least one of the one or more retransmission metrics describes an amount of time that the wireless communication device has monitored for a retransmission that never came or an amount of time that the wireless communication device has monitored for an assignment or grant, for a retransmission, that never came.

B10. The method of embodiment B9, wherein the at least one of the one or more retransmission metrics indicates the amount of time absolutely, indicates the amount of time as a portion of a wake-up time, or indicates whether the amount of time is increasing or decreasing over time.

B11. The method of any of embodiments B9-B10, wherein the amount of time is the average amount of time that the wireless communication device has monitored for a retransmission that never came.

B12. The method of any of embodiments B9-B111, wherein at least one of the one or more retransmission metrics is a statistical metric.

B13. The method of any of embodiments B1-B12, wherein the assistance information indicates a value measured by the wireless communication device for each of one or more traffic metrics that describe uplink or downlink data traffic in C-DRX operation.

B14. The method of any of embodiments B1-B13, wherein at least one of the one or more traffic metrics indicates:
a delay budget for uplink or downlink data traffic in C-DRX operation;
a traffic arrival periodicity for uplink or downlink data traffic in C-DRX operation;
a jitter for uplink or downlink data traffic in C-DRX operation;
a packet size for uplink or downlink data traffic in C-DRX operation;
a quality of service flow identifier for uplink or downlink data traffic in C-DRX operation; or
a buffer size for uplink or downlink data traffic in C-DRX operation.

B15. The method of embodiment B14, wherein the at least one of the one or more traffic metrics is a statistical metric.

B16. The method of any of embodiments B1-B15, wherein the assistance information comprises assistance information specific for each of one or more quality of service flows or data radio bearers.

B17. The method of any of embodiments B1-B16, wherein the assistance information is user equipment, UE, assistance information, UAI.

B18. The method of any of embodiments B1-B17, further comprising transmitting, to the wireless communication device, configuration signaling that configures the wireless communication device to provide said assistance information.

B19. The method of any of embodiments B1-B18, further comprising transmitting, to the wireless communication device, configuration signaling that configures, for at least one retransmission parameter of the one or more retransmission parameters, a set of values from which the wireless communication device is allowed to provide a preferred value for the at least one retransmission parameter.

B20. The method of embodiment 19, wherein the set of values is a proper subset of a set of allowed values.

B21. The method of embodiment B20, wherein the proper subset includes one or more values that are smaller than a value currently configured for the at least one retransmission parameter.

B22. The method of any of embodiments B1-B21, further comprising transmitting, to the wireless communication device, configuration signaling that configures a value of a prohibit timer of the wireless communication device that, while the prohibit timer is running at the wireless communication device, prohibits the transmission of:
assistance information which provides a preference of the wireless communication device on any of the one or more retransmission parameters; or
assistance information which provides a preference of the wireless communication device on a subset of the one or more retransmission parameters.

B23. The method of any of embodiments B1-B22, further comprising, based on the received assistance information, configuring or controlling retransmission in C-DRX operation.

B24. The method of embodiment B23, wherein said configuring or controlling comprises configuring one or more retransmission parameters that control retransmission in C-DRX operation.

B25. The method of embodiment B24, wherein configuring one or more retransmission parameters comprises configuring one or more of:
a downlink retransmission timer that controls a maximum duration until a downlink retransmission is received;
an uplink retransmission timer that controls a maximum duration until a grant for an uplink retransmission is received;
a downlink hybrid automatic repeat request, HARQ, round-trip time timer that controls a minimum duration before a downlink assignment for HARQ retransmission is expected by a medium access control, MAC, entity; and
an uplink HARQ round-trip time timer that controls a minimum duration before an uplink HARQ retransmission grant is expected by a MAC entity.

B26. The method of any of embodiments B24-B25, wherein the assistance information comprises assistance information specific for each of one or more quality of service, QoS, flows or data radio bearers, DRBs, wherein configuring one or more retransmission parameters that control retransmission in C-DRX operation comprises, for each of the one or more QoS flows or DRBs, configuring a respective set of one or more retransmission parameters that is specific to that QoS flow or DRB, and wherein the method further comprises transmitting signaling that indicates which set of one or more retransmission parameters is active.

B27. The method of any of embodiments B24-B25, wherein the assistance information comprises assistance information specific for each of multiple quality of service, QoS, flows or data radio bearers, DRBs, wherein the method further comprises configuring the wireless communication device with multiple sets of one or more transmission parameters that control retransmission in C-DRX operation and that are specific to respective ones of the multiple QoS flows or DRBs.

B28. The method of embodiment B27, further comprising dynamically or semi-statically activating a set of one or more transmission parameters, from the multiple sets of one or more transmission parameters, for a transmission associated with the QoS flow or DRB specific to that set.

B29. The method of embodiment B28, wherein said activating comprises transmitting, in a grant or assignment scheduling the transmission, explicit signaling that activates the set.

BB. The method of any of the previous embodiments, further comprising:
obtaining user data; and
forwarding the user data to a host or a user equipment.

### Group C Embodiments

C1. A wireless device configured to perform any of the steps of any of the Group A embodiments.

C2. A wireless device comprising processing circuitry configured to perform any of the steps of any of the Group A embodiments.

C3. A wireless device comprising:
communication circuitry; and
processing circuitry configured to perform any of the steps of any of the Group A embodiments.

C4. A wireless device comprising:
processing circuitry configured to perform any of the steps of any of the Group A embodiments; and
power supply circuitry configured to supply power to the wireless device.

C5. A wireless device comprising:
processing circuitry and memory, the memory containing instructions executable by the processing circuitry whereby the wireless device is configured to perform any of the steps of any of the Group A embodiments.

C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C7. A computer program comprising instructions which, when executed by at least one processor of a wireless device, causes the wireless device to carry out the steps of any of the Group A embodiments.

C8. A carrier containing the computer program of embodiment C7, wherein the carrier is one of an electronic signal, optical signal, radio signal, or computer readable storage medium.

C9. A network node configured to perform any of the steps of any of the Group B embodiments.

C10. A network node comprising processing circuitry configured to perform any of the steps of any of the Group B embodiments.

C11. A network node comprising:
communication circuitry; and
processing circuitry configured to perform any of the steps of any of the Group B embodiments.

C12. A network node comprising:
processing circuitry configured to perform any of the steps of any of the Group B embodiments;
power supply circuitry configured to supply power to the network node.

C13. A network node comprising:
processing circuitry and memory, the memory containing instructions executable by the processing circuitry whereby the network node is configured to perform any of the steps of any of the Group B embodiments.

C14. The network node of any of embodiments C9-C13, wherein the network node is a base station.

C15. A computer program comprising instructions which, when executed by at least one processor of a network node, causes the network node to carry out the steps of any of the Group B embodiments.

C16. The computer program of embodiment C14, wherein the network node is a base station.

C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

D2. The communication system of the previous embodiment further including the base station.

D3. The communication system of the previous 2 embodiments, further including the UE, wherein the UE is configured to communicate with the base station.

D4. The communication system of the previous 3 embodiments, wherein:
the processing circuitry of the host computer is configured to execute a host application, thereby providing the user data; and
the UE comprises processing circuitry configured to execute a client application associated with the host application.

D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

D6. The method of the previous embodiment, further comprising, at the base station, transmitting the user data.

D7. The method of the previous 2 embodiments, wherein the user data is provided at the host computer by executing a host application, the method further comprising, at the UE, executing a client application associated with the host application.

D8. A user equipment (UE) configured to communicate with a base station, the UE comprising a radio interface and processing circuitry configured to perform any of the previous 3 embodiments.

D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

D10. The communication system of the previous embodiment, wherein the cellular network further includes a base station configured to communicate with the UE.

D11. The communication system of the previous 2 embodiments, wherein:
the processing circuitry of the host computer is configured to execute a host application, thereby providing the user data; and
the UE's processing circuitry is configured to execute a client application associated with the host application.

D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

D13. The method of the previous embodiment, further comprising at the UE, receiving the user data from the base station.

D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

D15. The communication system of the previous embodiment, further including the UE.

D16. The communication system of the previous 2 embodiments, further including the base station, wherein the base station comprises a radio interface configured to communicate with the UE and a communication interface configured to forward to the host computer the user data carried by a transmission from the UE to the base station.

D17. The communication system of the previous 3 embodiments, wherein:
the processing circuitry of the host computer is configured to execute a host application; and
the UE's processing circuitry is configured to execute a client application associated with the host application, thereby providing the user data.

D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

D19. A method implemented in a communication system including a host computer, a base station and a user equipment (UE), the method comprising:
at the host computer, receiving user data transmitted to the base station from the UE, wherein the UE performs any of the steps of any of the Group A embodiments.

D20. The method of the previous embodiment, further comprising, at the UE, providing the user data to the base station.

D21. The method of the previous 2 embodiments, further comprising:
at the UE, executing a client application, thereby providing the user data to be transmitted; and
at the host computer, executing a host application associated with the client application.

D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

D24. The communication system of the previous embodiment further including the base station.

D25. The communication system of the previous 2 embodiments, further including the UE, wherein the UE is configured to communicate with the base station.

D26. The communication system of the previous 3 embodiments, wherein:
the processing circuitry of the host computer is configured to execute a host application;
the UE is configured to execute a client application associated with the host application, thereby providing the user data to be received by the host computer.

D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

D28. The method of the previous embodiment, further comprising at the base station, receiving the user data from the UE.

D29. The method of the previous 2 embodiments, further comprising at the base station, initiating a transmission of the received user data to the host computer.

1.-40. (canceled)

41. A method performed by a wireless communication device, the method comprising:
transmitting, to a wireless communication network, assistance information indicating:
a preference of the wireless communication device for each of one or more retransmission parameters that control retransmission in connected mode discontinuous reception (C-DRX) operation, wherein at least one of the one or more retransmission parameters controls a maximum number of uplink and/or downlink retransmissions in C-DRX operation and/or at least one of the one or more retransmission parameters controls a maximum window of time within which any retransmission of an original transmission is transmittable since the original transmission was transmitted or scheduled;
a value measured by the wireless communication device for each of one or more retransmission metrics that describe retransmission in C-DRX operation;
and/or a value measured by the wireless communication device for each of one or more traffic metrics that describe uplink or downlink data traffic in C-DRX operation.

42. The method of claim 41, wherein the assistance information indicates a preference of the wireless communication device for each of one or more retransmission parameters that control retransmission in C-DRX operation.

43. The method of claim 42, wherein at least one of the one or more retransmission parameters controls a timing of retransmission in C-DRX operation and/or a timing of control signaling for controlling retransmission in C-DRX operation.

44. The method of claim 42, wherein the one or more retransmission parameters include one or more of:
a downlink retransmission timer that controls a maximum duration until a downlink retransmission is received;
an uplink retransmission timer that controls a maximum duration until a grant for an uplink retransmission is received;
a downlink hybrid automatic repeat request (HARQ) round-trip time timer that controls a minimum duration before a downlink assignment for HARQ retransmission is expected by a medium access control (MAC) entity; and
an uplink HARQ round-trip time timer that controls a minimum duration before an uplink HARQ retransmission grant is expected by a MAC entity.

45. The method of claim 41, wherein the assistance information indicates a value measured by the wireless communication device for each of one or more retransmission metrics, wherein at least one of the one or more retransmission metrics describes an amount of time that the wireless communication device has monitored for a retransmission that never came or an amount of time that the wireless communication device has monitored for an assignment or grant, for a retransmission, that never came.

46. The method of claim 41, wherein the assistance information indicates a value measured by the wireless communication device for each of one or more traffic metrics that describe uplink or downlink data traffic in C-DRX operation.

47. The method of claim 46, wherein at least one of the one or more traffic metrics indicates:
a delay budget for uplink or downlink data traffic in C-DRX operation;
a traffic arrival periodicity for uplink or downlink data traffic in C-DRX operation;
a jitter for uplink or downlink data traffic in C-DRX operation;
a packet size for uplink or downlink data traffic in C-DRX operation;
a quality of service flow identifier for uplink or downlink data traffic in C-DRX operation; or
a buffer size for uplink or downlink data traffic in C-DRX operation.

48. The method of claim 41, further comprising receiving, from the wireless communication network, configuration signaling that configures, for at least one retransmission parameter of the one or more retransmission parameters, a set of values from which the wireless communication device is allowed to provide a preferred value for the at least one retransmission parameter.

49. The method of claim 41, further comprising:
receiving configuration signaling that configures the one or more retransmission parameters; and
operating in C-DRX operation according to the one or more retransmission parameters as configured.

50. A method performed by a network node configured for use in a wireless communication network, the method comprising:
receiving, from a wireless communication device, assistance information indicating:
a preference of the wireless communication device for each of one or more retransmission parameters that control retransmission in connected mode discontinuous reception (C-DRX) operation, wherein at least one of the one or more retransmission parameters controls a maximum number of uplink and/or downlink retransmissions in C-DRX operation and/or at least one of the one or more retransmission parameters controls a maximum window of time within which any retransmission of an original transmission is transmittable since the original transmission was transmitted or scheduled;
a value measured by the wireless communication device for each of one or more retransmission metrics that describe retransmission in C-DRX operation;
and/or a value measured by the wireless communication device for each of one or more traffic metrics that describe uplink or downlink data traffic in C-DRX operation.

51. The method of claim 50, wherein the assistance information indicates a preference of the wireless communication device for each of one or more retransmission parameters that control retransmission in C-DRX operation.

52. The method of claim 51, wherein at least one of the one or more retransmission parameters controls a timing of retransmission in C-DRX operation and/or a timing of control signaling for controlling retransmission in C-DRX operation.

53. The method of claim 51, wherein the one or more retransmission parameters include one or more of:
a downlink retransmission timer that controls a maximum duration until a downlink retransmission is received;
an uplink retransmission timer that controls a maximum duration until a grant for an uplink retransmission is received;
a downlink hybrid automatic repeat request (HARQ) round-trip time timer that controls a minimum duration before a downlink assignment for HARQ retransmission is expected by a medium access control (MAC) entity; and
an uplink HARQ round-trip time timer that controls a minimum duration before an uplink HARQ retransmission grant is expected by a MAC entity.

54. The method of claim 50, wherein the assistance information indicates a value measured by the wireless communication device for each of one or more retransmission metrics, wherein at least one of the one or more retransmission metrics describes an amount of time that the wireless communication device has monitored for a retransmission that never came or an amount of time that the wireless communication device has monitored for an assignment or grant, for a retransmission, that never came.

55. The method of claim 50, wherein the assistance information indicates a value measured by the wireless communication device for each of one or more traffic metrics that describe uplink or downlink data traffic in C-DRX operation.

56. The method of claim 55, wherein at least one of the one or more traffic metrics indicates:
a delay budget for uplink or downlink data traffic in C-DRX operation;
a traffic arrival periodicity for uplink or downlink data traffic in C-DRX operation;
a jitter for uplink or downlink data traffic in C-DRX operation;
a packet size for uplink or downlink data traffic in C-DRX operation;
a quality of service flow identifier for uplink or downlink data traffic in C-DRX operation; or
a buffer size for uplink or downlink data traffic in C-DRX operation.

57. The method of claim 50, wherein the assistance information comprises assistance information specific for each of one or more quality of service flows or data radio bearers.

58. The method of claim 50, further comprising transmitting, to the wireless communication device, configuration signaling that configures, for at least one retransmission parameter of the one or more retransmission parameters, a set of values from which the wireless communication device is allowed to provide a preferred value for the at least one retransmission parameter.

59. The method of claim 50, further comprising, based on the received assistance information, configuring or controlling retransmission in C-DRX operation.

60. The method of claim 59, wherein said configuring or controlling comprises configuring one or more retransmission parameters that control retransmission in C-DRX operation, wherein configuring one or more retransmission parameters comprises configuring one or more of:
a downlink retransmission timer that controls a maximum duration until a downlink retransmission is received;
an uplink retransmission timer that controls a maximum duration until a grant for an uplink retransmission is received;
a downlink hybrid automatic repeat request (HARQ) round-trip time timer that controls a minimum duration before a downlink assignment for HARQ retransmission is expected by a medium access control (MAC) entity; and
an uplink HARQ round-trip time timer that controls a minimum duration before an uplink HARQ retransmission grant is expected by a MAC entity.

61. The method of claim 59, wherein the assistance information comprises assistance information specific for each of multiple quality of service (QoS) flows or data radio bearers (DRBs), wherein the method further comprises:
configuring the wireless communication device with multiple sets of one or more transmission parameters that control retransmission in C-DRX operation and that are specific to respective ones of the multiple QoS flows or DRBs; and
dynamically or semi-statically activating a set of one or more transmission parameters, from the multiple sets of one or more transmission parameters, for a transmission associated with the QoS flow or DRB specific to that set, wherein said activating comprises transmitting, in a grant or assignment scheduling the transmission, explicit signaling that activates the set.

62. A wireless communication device, the wireless communication device comprising:
communication circuitry; and
processing circuitry configured to transmit, to a wireless communication network, via the communication circuitry, assistance information indicating:
a preference of the wireless communication device for each of one or more retransmission parameters that control retransmission in connected mode discontinuous reception (C-DRX) operation, wherein at least one of the one or more retransmission parameters controls a maximum number of uplink and/or downlink retransmissions in C-DRX operation and/or at least one of the one or more retransmission parameters controls a maximum window of time within which any retransmission of an original transmission is transmittable since the original transmission was transmitted or scheduled;
a value measured by the wireless communication device for each of one or more retransmission metrics that describe retransmission in C-DRX operation; and/or
a value measured by the wireless communication device for each of one or more traffic metrics that describe uplink or downlink data traffic in C-DRX operation.

63. A network node configured for use in a wireless communication network, the network node comprising:
communication circuitry; and
processing circuitry configured to receive, from a wireless communication device, via the communication circuitry, assistance information indicating:
a preference of the wireless communication device for each of one or more retransmission parameters that control retransmission in connected mode discontinuous reception (C-DRX) operation;
a value measured by the wireless communication device for each of one or more retransmission metrics that describe retransmission in C-DRX operation; and/or
a value measured by the wireless communication device for each of one or more traffic metrics that describe uplink or downlink data traffic in C-DRX operation.
